(19) United States
(12) Patent Application Publication
(10) Pub. No.: US 2026/0077277 A1
(43) Pub. Date: Mar. 19, 2026

(54) DILUTABLE COMPOSITIONS AND PROCESSES FOR EXTRACTING AND REFINING POORLY WATER-SOLUBLE POLAR OILS FROM BIOMASS

(71) Applicant: Micellae Delivery Systems Inc., Toronto (CA)

(72) Inventors: Mehdi NOURAEI, Toronto (CA); Edgar ACOSTA, Toronto (CA); Masoumeh MESKINFAM LANGROUDI, Richmond Hill (CA)

(73) Assignee: Micellae Delivery Systems Inc., Toronto, ON (CA)

(21) Appl. No.: 19/106,561

(22) PCT Filed: Aug. 29, 2023
(86) PCT No.: PCT/CA2023/051145

§ 371 Date: Feb. 25, 2025

Related U.S. Application Data
(60) Provisional application No. 63/402,360, filed on Aug. 30, 2022.

(51) Int. Cl. B01D 11/02; B01D 9/00

(52) U.S. Cl. CPC B01D 11/0257; B01D 9/0031; B01D 9/0054; B01D 11/0288

(57) ABSTRACT

A method of extraction of one or more polar oils from a biomass substrate into an oily surfactant extract phase (OSEP), the method comprising: i) mixing an aqueous diluting solution, a dilutable extraction media (DtableEM) and the biomass substrate containing one or more polar oils to obtain a mixture having a biomass residue and a liquid phase comprising an emulsified OSEP and an excess aqueous phase, the DtableEM comprising: (a) 0 to 10% of a surfactant, having at least one hydrocarbon group with 12 to 18 carbon atoms; (b) a hydrophilic linker, having one hydrocarbon group with 6 to 10 carbon atoms; and (c) a solvent oil, excluding linear alkanes; ii) separating the biomass residue in the mixture from the liquid phase; and iii) separating in the liquid phase the excess aqueous phase from the emulsified OSEP to obtain the OSEP containing the extracted one or more polar oils.

### FIELD

The present disclosure relates to dilutable compositions and processes for the extraction of poorly water-soluble polar oils (as defined herein) from plants and other biomass substrates. The present disclosure further discloses processes to increase the concentration of the extracted polar oil present in the oily surfactant extract and produce a refined extract.

### BACKGROUND

All essential oils, oleoresins and many active pharmaceutical and nutritional ingredients (APIs and ANIs) are extracted from biomass, including plant flowers, barks, seeds, fruits and fruit peels [1]. Nearly all essential oils, oleoresins, and most APIs and ANIs have polar groups such as alcohols, carboxylic groups, amine groups, ethers, amides. The polar nature of these substances is not enough to make them water-soluble, but they are polar enough to preferentially associate with polar substances like alcohols and surfactants.

Most essential oils, oleoresins and APIs or ANIs are recovered by steam or solvent extraction. Steam extraction involves the evaporation of the extracted component as a result of the heat introduced by steam. The vapor of the extracted oil then condenses, forming a second oily phase, in addition to the steam condensate, often referred to as the hydrosol [1]. The oily phase is then gravity-separated from the aqueous phase. This method of extraction is not effective for oils with low volatility. The advantages of steam distillation include that it is well-known, that most products have been designed based on the composition profile obtained via steam distillation, and that it is relatively simple to set up and operate. The disadvantages of the method include its poor extraction efficiency for low volatility oils, long extraction times (typically 2 to 8 hours per batch but as high as 24 hours for rose petals), high energy consumption (production of steam), high water consumption (several hundreds of grams of water per gram of oil extracted), significant transference of some of the essential oils to the hydrosol fraction, and the potential of thermal degradation of the components due to the prolonged exposure to high temperatures [2].

Solvent extraction of essential oils and oleoresins is also an alternative technology for oil extraction. This extraction method can be quite effective, but it requires the solvent to be removed and recovered for reuse in a distillation step. There are cold (room temperature) extraction processes, as well as Soxhlet recycle processes. Cold extraction processes often use solvent to plant mass ratios ranging from 5 to 10 [3]. Considering that most oil content in suitable substrate range from 5 to 30%, this means a solvent to extracted oil ratios ranging from 16 to 200. Compared to steam distillation, solvent extraction can be faster, but it is still a process that can take hours of extraction per batch [1]. The use of additional energy inputs such as microwave-assisted and ultrasound-assisted extraction has also been disclosed, but the additional energy requirements of such processes, plus the additional complexity of the extraction equipment, are undesirable features for those processes [2]. Non-polar solvents like C5-C8 alkanes can be used, but polar solvents such as C1-C3 alcohols, acetone, and halogenated solvents have also been used [1,2].

A variant of the solvent extraction method is the Supercritical Fluid Extraction (SFE) method. This extraction method uses the low viscosity of supercritical fluids to easily penetrate all parts of the porous matrix of the biomass substrate and the relatively high solubility of the oil in the fluid to extract the oil. After the extraction, the fluid is then depressurized to release a mist of extracted oil, turning the superficial fluid into a gas that separates from the extracted oil [1]. The gas is then cooled to turn this again into a liquid. The mass of CO₂ required per gram of extracted oil depends on the pressure used during extraction. For example, for CO₂ SFE of cannabis plant, one requires about 600 grams of CO₂ per gram of oil extracted when operating the system at 100 bar and about 100 g/g when the extraction is conducted at 300 bar [4]. To improve the extraction efficiency of polar components such as cannabinoids, supercritical CO₂ is often mixed with a polar solvent such as ethanol. The extraction time is highly dependent on the pressure used. Higher extraction pressures can lead to shorter extraction times, as short as 1 to 2 hours in some cases. In addition to CO₂ losses in the process, the main disadvantage of SFE is the high pressures required. This often means either small extraction vessels or large vessels with thick walls, which often translate into high capital costs for the equipment and elaborate protocols for loading and unloading the biomass and collecting the extracted material.

The use of surfactant solutions to extract biomass substrates, albeit not yet utilized in large-scale extraction, has offered some benefits over solvent-only and steam extraction. There are various versions of surfactant-based extractions. The capillary displacement (CD) extraction reported by Sabatini and others uses dilute (<1 wt %) solution of anionic alkyl propoxy sulfate surfactants, also known as extended surfactants to produce low (<0.1 mN/m) interfacial tensions with triglycerides [5]. Reaching low interfacial tension is important to overcome the capillary forces that trap oils in the porous matrix of the biomass substrate. Under these conditions, shear forces can overcome the capillary forces to displace (remove) the oil from the biomass. The oil is emulsified (not solubilized) in the aqueous phase and later removed via centrifugation. The average practitioner in the area of oil extraction from plants would regard the formation of emulsions as a negative outcome because most emulsions are difficult to break [6]. However, it has been found that if the emulsion is produced at the point of phase inversion and with ultralow interfacial tensions, the emulsion stability can be brought down by several orders of magnitude. Therefore, the use of capillary displacement with low interfacial tension not only facilitates the displacement and emulsification of the extracted oil it also facilitates the breaking of the emulsion under mild centrifugation conditions. From the bench-scale extraction studies, capillary displacement could yield over 80% of extraction efficiency and improve the quality of the extracted oil as compared to solvent extraction [5].

There is ample literature on the use of diluted surfactant solutions (<1 wt %) to promote the capillary displacement of crude oil from reservoirs [7]. That literature is not relevant to the current disclosure because of the non-polar nature of most crude oils and because the pore structure, pressure, wettability and solid properties of oil reservoirs are different from those of biomass substrates.

Another method of surfactant-based extraction of oils is solubilization in the microemulsion. Chan (2012) used a combination of lecithin as the main surfactant, a lipophilic linker, sorbitan monooleate (Span® 80), a hydrophilic linker, PEG-6-caprylic/capric glycerides (Softigen 767) and ethyl caprate as an oily solvent to produce microemulsions that could solubilize triglycerides and carotenoids from a microalgae substrate to produce single-phase microemulsions being continuous in water, continuous in oil, or bicontinuous in oil and water [8]. According to Chan's data for the bicontinuous systems, the extraction efficiency of oil from microalgae was nearly 100% after 3 hours of extraction, using a microemulsion to dry microalgae mass ratio of 20. Chan indicated that the microemulsion/biomass ratio can range from 6 to 60, where using larger ratios improved the extraction efficiency. Considering 8% oil content in the algae, the microemulsion/microalgae ratio of 20 corresponds to a microemulsion/extract oil ratio of 250. Chan's determined that using ethyl caprate alone under the same conditions would only remove 80% of the triglycerides present in the system. It is important to highlight that the extracting microemulsion used by Chan produced single-phase systems after extraction. The extracted oil is still associated with the surfactant and the solvent oil (ethyl caprate). More recently, Garti et al. (US patent application publication No. 2019/0231833A1) disclosed the use of fully dilutable single-phase microemulsions to extract cannabinoids. Similar to Chan's systems, Garti's system promotes the solubilization of cannabinoids (that are polar oils) in the single-phase microemulsion system. Garti's extracts are meant for direct use as delivery systems. The fact that no excess oil or aqueous phases are formed after the extraction is given as a sign that these fully dilutable systems experience zero interfacial tension. Furthermore, Garti's disclosure points to the undesirability of multiphase (emulsion) extraction because the unstable nature of the resulting emulsion is expected to reduce the extraction yield. In one embodiment, identified in Garti's Table 1 as composition AX1, a water-dilutable microemulsion preconcentrate comprising of 5% limonene, 45% polyethylene glycol (PEG) sorbitan monooleate, 45% propylene glycol, and 5% ethanol was used as extraction media for Cannabidiol (CBD). The undiluted AX-1 composition was used to extract a cannabis strain (MI-1) containing atotal of 14.8% of total extractable cannabinoids. According to FIG. 8 in that disclosure, the minimal microemulsion preconcentrate to plant mass ratio was 15 and considering the total extractable cannabinoids; this would represent a microemulsion preconcentrate to extractable oil ratio of 101 g/g.

Unfortunately, the high affinity of polar oils, such as cannabinoids, for surfactants makes the surfactant-polar oil separation particularly difficult. This is not an aspect of concern in Garti's disclosure because the product combines the surfactant and the extracted polar oil. However, the single-phase extraction has the potential to carry water-soluble/dispersible contaminants into the extracted product. Most agrochemicals, including pesticide formulations, are either water-soluble or water-dispersible to facilitate the application of the product and the removal via aqueous washing before consumption [9]. Although the compositions and methods of extraction herein disclosed are not a replacement for pre-washing biomass substrates, the formation of an excess aqueous phase provides an additional layer of protection against the potential for the co-extraction of undesirable components into the oily surfactant extract phase.

In some applications, it is important to have nearly pure polar oils, such as pharmaceutical applications, which makes it extremely important to identify a path to increase the concentration of the polar oil in the extract. The compositions and processes hereby disclosed aim to produce oily microemulsions with an excess aqueous phase formed during extraction, where a sequence of separations leads to the removal of water, water-soluble or water-dispersible components, hydrophilic linker, and the solvent oil.

The disclosed compositions are capable of producing low (<0.1 mN/m) interfacial tensions (IFT) between an oily surfactant extract phase (OSEP), containing the solvent oil, the polar oil, and the surfactants; and an excess aqueous phase containing water-soluble or dispersible components. Undesirable water-soluble or water-dispersible residues can include salts, tannins and other polyphenols, water-soluble gums, and water-soluble or water-dispersible fertilizers, pesticides and other agrochemicals. The advantage of producing low IFT is connected to the reduction of the capillary forces that keep oil phases trapped in the porous structure of the biomass matrix. This principle is used in Sabatini et al. to extract vegetable oils from seeds using dilute solutions of surfactants (˜0.1% surfactant) without any solvent oil [5]. In those cases, the vegetable oil is still in a liquid phase and can be mobilized from the porous media without a solvent oil. Furthermore, although the triglycerides in vegetable oils have some polarity, they have been found to behave more like regular non-polar alkanes with a positive equivalent alkane carbon number (EACN) ranging from +14 to +20. Such hydrophobic alkane-like behavior of vegetable oils contrasts with the highly surfactant-like behavior of polar oils that make them associate with the surfactants used in the extraction process.

U.S. Pat. No. 10,973,864 B2 discloses the use of a two-phase extraction media for cannabinoids (that can be classified as polar oils) that includes the use of a lipid-based extractant that can involve a triglyceride or even a terpene. However, the extraction requires enzymes that help break down the biomass substrate and liberate the oil. According to U.S. Pat. No. 10,973,864 B2, the preferred extraction temperature for such enzyme-aided extraction ranges from 40° C. to 75° C. The use of enzymes and high extraction temperatures are not desirable features in an extraction process due to the cost associated with enzymes, and the use of high temperatures require not only additional heat requirements but also an increase in equipment complexity to provide a contact area with a heating fluid.

The use of a two-phase extraction media is not desirable because, upon contact with the biomass substrate, there is no guarantee that the dispersed media can penetrate the fibrous network of the biomass. The extraction strategy disclosed herein uses a single-phase diluted microemulsion as extraction media. Because the microemulsion is the continuous phase and has drop sizes in the order of ˜200 nm or less, they can easily penetrate biomass tissues and come in direct contact with the oil bodies of the substrate. The presence of a hydrophilic linker with 6 to 10 carbons in its hydrophobic tail and the presence of a balanced surfactant with 12 or more carbons in its hydrophobic tail (such as lecithin) helps promote what has been termed the combined linker assembly [10]. According to this combined linker assembly, the main surfactant helps bring together the hydrophilic linker (provided in the dilutable extraction media) and the lipophilic linker. However, as it will be shown later in Example 14, the presence of a surfactant, such as lecithin, although preferred, it is not strictly necessary. Lipophilic linkers are classified as polar oils according to the definition of a polar being poorly water-soluble, being oil soluble and having polar hydrogen bonding groups. During the extraction process, the extracted polar oil takes the role of the lipophilic linker, which is then incorporated by the hydrophilic linker and the balance surfactant into the microemulsion system. The formation of the second phase in the disclosed extraction process occurs after the polar oil is incorporated.

The complexity of developing a dilutable extracting media composition that forms a single-phase (fully dilutable) before extraction but that would produce an excess aqueous and an oily surfactant phase after extraction, having a low (<0.1 mN/m) interfacial tension is explained via the hydrophilic-lipophilic difference (HLD) framework. For systems comprising nonionic or neutral surfactants such as those herein disclosed [11]:

$$HLD = b \cdot S - k \cdot EACN + Cc + {c}_{T} \cdot ( T - 25 °C . ) \qquad ( 1 )$$

where b, k and c_{T} are constants for a given surfactant. S is the salinity of the aqueous phase, in g NaCl/100 mL. For NaCl, the value of b is often taken as 0.13; for most surfactants, the value k is taken as 0.16. The value of c_{T} depends on the specific hydrophilic group of the surfactant. T is the temperature in Celsius. Cc is the characteristic curvature of the surfactant, which is negative for hydrophilic surfactants and positive for hydrophobic surfactants. EACN is the equivalent alkane carbon number of the oil, and for linear alkanes, their EACN is the number of carbons in the molecule.

Nouraei et al. disclosure of fully dilutable formulations for the delivery of polar oils use the HLD framework to define poorly soluble polar oils as an active ingredient having water solubility lower than 1 wt %, log P greater than 1.5, and a positive characteristic curvature (Cc), or negative apparent EACN [U.S. provisional patent application 63/132,683]. The disclosure includes ibuprofen, nonylphenol, eugenol, benzocaine and cannabidiol (CBD) as examples of polar oils. Eugenol and CBD, in particular, have water solubilities of 0.14 and 0.0013 wt %, respectively; they have log P values of 2.7 and 6.1, respectively; and they have Cc values of +2.8 and +2.6, respectively. While eugenol and cannabinoids are examples of polar oils, vegetable oils that do not contain free fatty acids have positive EACN values. The complexity of working with polar oils originates from the fact that even at very low concentrations, they segregate with the surfactant at the oil-water interface, resulting in the surfactant-like behavior of polar oils [12]. In that case, the Cc value of the surfactant+polar oil mixture can be calculated as:

$${Cc}_{mix} = {x}_{polar \_ oil} \cdot {Cc}_{polar \_ oil} + ( 1 - {x}_{polar oil} ) \cdot {Cc}_{surfactant} \qquad ( 2 )$$

where Ccₘᵢₓ is the Cc of the mixture of polar oil and surfactant at the interface, and x_{polar_oil} is the molar fraction of the polar oil in mixture with the surfactant. When designing an extracting system for polar oils, one must consider that low and ultralow interfacial tensions are achieved when HLD˜0 [13]. To illustrate this approach for the extraction of eugenol (Cc_{polar_oil}=+2.8) with cyclohexane (EACN=3) as the microemulsion solvent oil at room temperature (T=25C), in the absence of salts (S=0), and considering k=0.16 [13], then Eq. (1) indicates that to obtain HLD=0, a Ccₘᵢₓ should be +0.16*3=+0.48. Considering the Cc of eugenol, and assuming x_{polar_oil} of 0.1, 0.5, and 0.9, then according to Eq.(2), the mixed Cc of the surfactant+hydrophilic linker for each x_{polar_oil} should be +0.2, −1.8, and −20, respectively. This calculation demonstrates that the negative Cc of the hydrophilic linker is essential to improve the extraction of polar oil (high x_{polar_oil}).

### SUMMARY

The present disclosure entails (a) dilutable microemulsion compositions used as dilutable extraction media (DtableEM) for polar oils from biomass substrates, (b) extraction processes that use the DtableEM to produce an oily surfactant extract phase (OSEP), and (c) refining processes to concentrate the polar oil present in the OSEP to produce a refined extract (RefEx).

In one embodiment, the DtableEM compositions of the present disclosure are comprised of three components: (a_i) 0-10 wt % of a surfactant having C12+ carbons in its hydrocarbon tail group and an ionic, zwitterionic, or nonionic hydrophilic headgroup, (a_ii) a hydrophilic linker having a negative characteristic curvature (hydrophilic linker Cc<0), C6-C10 carbons in its hydrocarbon tail group and an ionic or nonionic hydrophilic headgroup, and (a iii) a hydrocarbon, except for linear alkanes (i.e., the hydrocarbon is not a linear alkane), as a solvent oil. In one aspect, the solvent oil has a boiling point of no more than 100° C. Upon addition of an aqueous diluting solution (Dsol) such as water, the DtableEM of the present disclosure produces a diluted extraction media (DtedEM) corresponding to microemulsions without excess oil or water and without the presence of highly viscous (>1000 Cp) liquid crystals.

In embodiments, polar oils that can be extracted with DtableEM compositions include poorly water-soluble substances having water solubility lower than 1 wt %, and a positive characteristic curvature (Cc), or negative apparent EACN.

Embodiments of the disclosed extraction processes are comprised of one or more of the following steps: (b_i) mixing the DtableEM, a diluting solution (Dsol), and a biomass substrate containing one or more polar oils; (b_ii) separation of the solid residual biomass; and (b_iii) separation of the oily surfactant extract phase (OSEP). Dsol is an aqueous solution that might contain electrolytes (less than 1 wt %), polymers (less than 1 wt %), and surfactants (less than 1 wt %). In one aspect, the Dsol is water, including mineral water, tap water and distilled water.

The OSEP refining process includes one or more of the following steps: (c_i) hydrophilic linker precipitation via the addition of a hydrophilic linker antisolvent to the OSEP, (c_ii) evaporation of aqueous solution and the solvent oil from the OSEP, (c_iii) cooling-crystallization of hydrophilic linker and water, and/or (c_iv) hydrophilic linker antisolvent evaporation.

In one embodiment, the OSEP refining process includes the following steps: (c_i) hydrophilic linker precipitation via the addition to the OSEP of a hydrophilic linker antisolvent, (c_ii) evaporation of water and solvent oil, (c_iii) cooling-crystallization of hydrophilic linker and water, and (c_iv) hydrophilic linker antisolvent evaporation.

In another embodiment, the OSEP refining process includes the following steps: (c_i) hydrophilic linker precipitation via the addition of a hydrophilic linker antisolvent, (c_iii) cooling-crystallization of hydrophilic linker and water, and (c_iv) hydrophilic linker antisolvent evaporation.

In another embodiment, the refining process includes (c_ii) evaporation of water and solvent oil to obtain a RefEx containing the extracted polar oil, the surfactant and the hydrophilic linker.

In one embodiment, the present disclosure provides for a method of extracting one or more polar oils from a biomass substrate into an oily surfactant extract phase (OSEP), the method comprising: b_i: mixing an aqueous diluting solution (Dsol), a dilutable extraction media (DtableEM) and the biomass substrate containing one or more polar oils to obtain a mixture having a biomass residue and a liquid phase, the liquid phase comprising an emulsified OSEP and an excess aqeuous phase, the DtableEM comprising: (a) 0 to 10% of a surfactant, having at least one hydrocarbon group with 12 to 18 carbon atoms; (b) a hydrophilic linker, having one hydrocarbon group with 6 to 10 carbon atoms; and (c) a solvent oil, excluding linear alkanes; b_ii: separating the biomass residue in the mixture from the liquid phase comprising the emulsified OSEP phase and the excess aqueous phase; and b_iii: separating the excess aqueous phase from the emulsified OSEP to obtain the OSEP containing the extracted one or more polar oils.

In one embodiment of the method of extracting one or more polar oils from a biomass substrate into an OSEP of the present disclosure, upon addition of the Dsol the DtableEM produces a diluted extraction media (DtedEM), and wherein the biomass substrate containing one or more polar oils: DtedEM ratio is from 1:6 to 1:60, or of 1:10 to 1:20.

In another embodiment of the method of extracting, the mixing of step b_i is done at a temperature from about 5° C. to 50° C.

In another embodiment of the method of extracting, the separation in b_ii and/or b_iii is gravity driven or pressure driven.

In another embodiment of the method of extracting, the DtableEM composition and the Dsol produce a final aqueous phase content of about 50 wt % to about 95 wt %.

In another embodiment of the method of extracting, when the DtableEM comprises more than 0% of the surfactant, the surfactant has food-grade status.

In another embodiment of the method of extracting, when the DtableEM comprises more than 0% of the surfactant, the surfactant includes one or more of lecithin, lysolecithins, mixtures of phosphatidylcholines and other lipids and containing at least 50% w/w of a mixture of mono- and di-alkyl phosphatidylcholines, phosphatidylethanolamines, phosphatidylinositols and phosphatidylglycerols obtained from animal (e.g., eggs), vegetable (e.g., soybean) sources or via synthetical means.

In another embodiment of the method of extracting, the DtableEM includes 0% of the surfactant.

In another embodiment of the method of extracting, the hydrophilic linker has food-grade status.

In another embodiment of the method of extracting, the hydrophilic linker comprises one or more of C6-C10 esters of polyhydric alcohols, polyvinyl alcohol, polyglycerols and their co-polymers with a degree of polymerization (n) higher than 2 (n>2), sucrose, maltose, oligosaccharides, polyglucosides (n>2), polyglucosamines, sorbitol, sorbitan, poly alpha hydroxy acids and their salts, C6-C10 phosphatidylcholines, phosphatidyl glycerols, or mixtures thereof.

In another embodiment of the method of extracting, the solvent oil has a food-grade additive status.

In another embodiment of the method of extracting, the solvent oil includes cyclohexane, fatty acid ethyl esters (such as ethyl caprate and ethyl oleate) and terpenes (limonene).

In another embodiment of the method of extracting, the solvent oil comprises of alkyl esters of fatty acids, monoglycerides, diglycerides, triglycerides, non-linear alkanes, terpenes, or mixtures thereof.

In another embodiment of the method of extracting, the solvent oil has a positive equivalent alkane carbon number (EACN).

In another embodiment of the method of extracting, the solvent oil concentration in the DtableEM is about 10 wt % to about 80 wt %.

In another embodiment of the method of extracting, the extracted one or more polar oils has/have a positive characteristic curvature (Cc), a molecular weight between 50 and 1,000 Daltons, a polar area greater than 0.0 Å², an aqueous solubility less than about 1 wt %, and a positive log P.

In another embodiment of the method of extracting one or more polar oils from a biomass substrate into an OSEP, the extracted one or more polar oils include/s one or more hydrogen bonding donor compounds selected from a group consisting of C5+ alcohols, amines, peptides, organic acids, anthranilic acids, aryl propionic acids, enolic acids, heteroaryl acetic acids, indole and indene acetic acids, salicylic acid derivatives, nucleic acids, alkylphenols, para-aminophenol derivatives, terpene phenolics, cannabinoids, alkaloids, peptides, and halogenated compounds.

In another embodiment of the method of extracting one or more polar oils from a biomass substrate into an OSEP, the Dsol is mineral, distilled or tap water.

In another embodiment of the method of extracting one or more polar oils from a biomass substrate into an OSEP, the Dsol is an aqueous solution that contains less than 1 wt % of a mixture of additives, wherein the mixture of additives includes one or more of electrolytes, polymers, and surfactants.

In another embodiment, the present disclosure provides for a method of extracting a polar oil from a biomass substrate into an oily surfactant extract phase (OSEP), the method comprising: i: placing a biomass substrate in a single-phase system free of polar oil, but comprising a diluted extraction media (DtedEM) located above the phase boundary region of the ternary phase diagram for said system, to achieve the establishment of a biomass residue phase and a liquid phase comprising the OSEP and an excess aqueous phase; ii: phase separating the biomass residue phase formed in i from the liquid phase; and iii: separating the excess aqueous phase from the liquid phase to obtain the OSEP containing the extracted polar oil, wherein the DtedEM comprises the DtableEM as defined in any one of the previous embodiments and an aqueous solution (Dsol).

In one embodiment of the method of extracting the polar oil from the biomass substrate into the OSEP of the present disclosure, the DtableEM composition and the Dsol produce a final aqueous phase content of about 50 wt % to about 95 wt %.

In another embodiment, the present disclosure relates to a method for refining the oily surfactant extract phase (OSEP) obtained in step b_iii of the method of extraction of the present disclosure into a refined extract (RefEx) with higher concentration of the extracted polar oil, the method comprising one or more of the following steps: c_i: mixing the OSEP containing the extracted polar oil obtained in step b_iii of the method of extraction of the present disclosure with a hydrophilic linker antisolvent to precipitate hydrophilic linker in the OSEP, and separating the precipitated hydrophilic linker, the hydrophilic linker antisolvent being a linear alkane with five or more carbon atoms; c_ii: heating the resulting OSEP of c_i to evaporate the solvent oil from the OSEP at a temperature above the boiling point of the solvent oil to obtain an OSEP substantially free of the solvent oil; c_iii: cooling the resulting OSEP of c_i or the OSEP substantially free of the solvent oil of step c_ii to induce solidification of the hydrophilic linker and aqueous solution into solids, and separating the solids, thereby obtaining an OSEP substantially free of hydrophilic linker and aqueous solution; and c_iv: removing the hydrophilic linker antisolvent by heating the resulting OSEP of c_iii at a temperature at or above the boiling point of the hydrophilic linker antisolvent, to obtain the RefEx with higher concentration of the extracted polar oil relative to the OSEP obtained in b_iii of the previous embodiment of the method of extracting.

In one embodiment of the method for refining the OSEP, the method comprises steps c_i, c_iii and c_iv.

In another embodiment of the method for refining the OSEP, the method excludes steps c_iii and c_iv.

In another embodiment of the method for refining the OSEP, the mixing of step c_i is conducted at a temperature below the largest value between the melting point of the solvent oil, the aqueous solution and/or the antisolvent.

In another embodiment of the method for refining the OSEP, the method comprises steps c_i, c_ii and c_iv, and excludes step c_iii.

In another embodiment of the method for refining the OSEP, the mixing of step c_i is conducted at a temperature below the largest melting point value between the melting point of the solvent oil, the aqueous solution and/or the antisolvent.

In another embodiment, the present disclosure provides for a dilutable extraction media (DtableEM) composition for a two-phase extraction of one or more polar oil active compounds from biomass substrates, the polar oil having a solubility lower than 1 wt %, comprising: (a) a surfactant, having at least one hydrocarbon group with 12 to 18 carbon atoms; (b) a hydrophilic linker, having one hydrocarbon group with 6 to 10, 12 carbon atoms; and (c) a solvent oil, excluding linear alkanes, having a boiling point of no more than 100° C.

In one embodiment of the DtableEM composition, the surfactant has food-grade status.

In another embodiment of the DtableEM composition, the surfactant is one or a combination of two or more of lecithin, lysolecithins, mixtures of phosphatidylcholines and other lipids and containing at least 50% w/w of a mixture of mono- and di-alkyl phosphatidylcholines, phosphatidylethanolamines, phosphatidylinositols and phosphatidylglycerols obtained from animal (e.g., eggs), vegetable (e.g., soybean) sources or via synthetical means.

In another embodiment of the DtableEM composition, the surfactant is an ionic surfactant.

In another embodiment of the DtableEM composition, the hydrophilic linker has food-grade status.

In another embodiment of the DtableEM composition, the hydrophilic linker comprises of one or a combination of two or more of C6-C10 esters of polyhydric alcohols, polyvinyl alcohol, polyglycerols and their co-polymers with a degree of polymerization (n) higher than 2 (n>2), sucrose, maltose, oligosaccharides, polyglucosides (n>2), polyglucosamines, sorbitol, sorbitan, poly alpha hydroxy acids and their salts, C6-C10 phosphatidylcholines, phosphatidyl glycerols, or mixtures thereof.

In another embodiment of the DtableEM composition, the solvent oil has a food-grade status.

In another embodiment of the DtableEM composition, the solvent oil is cyclohexane.

In another embodiment of the DtableEM composition, the solvent oil has a positive equivalent alkane carbon number (EACN).

In another embodiment of the DtableEM composition, the solvent oil concentration is about 10 wt % to about 80 wt %.

In another embodiment, the present disclosure provides for a diluted extracting media (DtedEM) composition comprising the DtableEM composition of any one of the previous embodiments diluted in an aqueous phase to produce a final aqueous phase content of about 50 wt % to about 95 wt %.

### BRIEF DESCRIPTION OF THE DRAWINGS

A detailed description of the preferred embodiments is provided herein below by way of example only and with reference to the following drawings, in which:

FIGS. 1A to 1C. FIG. 1A shows the effect of introducing a polar oil, THC (Cc=+2.7), into a diluted extraction media (DtedEM) Lecithin-polyglycerol caprylate-limonene (D50) at a 10/90 ratio with a diluting solution (Dsol) containing 100 mM sodium chloride, 2 mM lecithin and 7 mM sodium taurocholate in spring water. Upon addition of THC, the DtedEM microemulsion (capable of scattering the laser light) turned into a two-phase system, a bottom excess aqueous phase (no laser light scattering) and an oily top phase microemulsion. FIG. 1B shows the ternary phase diagram for the system microemulsion (μE) system of FIG. 1A before the addition of THC. The gray line represents the phase boundary for the μE+ excess oil region predicted using the HLD-NAC method of Nouraei and Acosta [14]. The diagram presents the location of the initial D50 DtableEM and the composition of the DtedEM after 10/90 dilution with Dsol. The dilution path follows the single-phase boundary calculated by the HLD-NAC method. FIG. 1C shows the ternary phase diagram after the addition of 2.4% THC into the system. The positive shift introduced by the polar oil, THC in this case, induces a phase separation of rejected water and atop microemulsion phase, consistent with the dashed boundary calculated by the HLD-NAC model. The location of the composition of the excess phase and the oily microemulsion are shown in the diagram.

FIG. 2 shows a schematic of the extraction steps, b_i through b_iii, involved in extracting a polar oil component from a biomass substrate using dilutable extraction media (DtableEM) to obtain an oily surfactant extract phase (OSEP). The schematic includes a picture of one extraction example showing the biomass residue at the bottom of the extraction vessel, the excess aqueous phase, and the top OSEP.

FIGS. 3A-3B show a schematic of the refinement steps involved in the processing of the oily surfactant extract phase (OSEP) to increase the concentration of polar oil in the refined extract (RefEx). FIG. 3A illustrates the refinement process for a DtableEM produced with a non-volatile solvent oil involving steps c_i, c_iii, and c_iv. FIG. 3B illustrates the refinement process for a DtableEM produced with a volatile solvent oil, including the entire train of separation steps c_i, c_ii (evaporation of the solvent oil), c_iii, and c_iv.

FIG. 4 illustrates the dilution test tubes for systems containing (from left to right) 50/50, 40/60, 30/70, 20/80, and 10/90 of DtableEM/Diluting solution (Dsol). For parts (a) through (f), the Dsol contains 100 mM sodium chloride, 2 mM lecithin and 7 mM sodium taurocholate in spring water. Part (a) D50 Lecithin (Le) polyglycerol-6-caprylate (PG6C10)-Limonene. Part (b) D50 Lecithin (Le) polyglycerol-6-caprylate (PG6C10)-Limonene:ethyl oleate (80:20). Part (c) D50 Lecithin (Le) polyglycerol-6-caprylate (PG6C10)-Limonene:ethyl caprate (80:20). Part (d) D50 Lecithin (Le) polyglycerol-6-caprylate (PG6C10)-cyclohexane. Part (e) D30 Lecithin (Le) polyglycerol-6-caprylate (PG6C10)-cyclohexane. Part (f) D50 Polyglycerol-6-caprylate (PG6C10)-cyclohexane. Part (g) D50 Lecithin (Le) polyglycerol-6-caprylate (PG6C10)-Limonene:ethyl oleate (80:20) and using mineral water only as Dsol.

In the drawings, various embodiments of the present disclosure are illustrated by way of examples. It is to be expressly understood that the description and drawings are only for the purpose of illustration and as an aid to understanding and are not intended as a definition of the limits of the present disclosure.

### DETAILED DESCRIPTION

Unless defined otherwise, all technical and scientific terms used herein have the same meanings as commonly understood by one of ordinary skill in the art to which this disclosure belongs. Although any methods and materials similar or equivalent to those described herein can be used in the practice or testing of the present disclosure, the preferred methods, devices and materials are now described. All technical and patent publications cited herein are incorporated herein by reference in their entirety. Nothing herein is to be construed as an admission that the disclosure is not entitled to antedate such disclosure by virtue of prior disclosure.

All numerical designations, e.g., pH, temperature, time, concentration and molecular weight, including ranges, are approximations which are varied (+) or (−) by increments of 1.0 or 0.1, as appropriate, or alternatively by a variation of +/−20%, +/−15%, or alternatively +/−10%, or alternatively +/−5% or alternatively +/−2%. It is to be understood, although not always explicitly stated, that all numerical designations are preceded by terms of degree such as “substantially”, “about” and “approximately”. It also is to be understood, although not always explicitly stated, that the reagents described herein are merely exemplary and that equivalents of such are known in the art.

As used in the specification and claims, the singular form “a”, “an” and “the” include plural references unless the context clearly dictates otherwise. For example, the term “a compound” includes a plurality of compounds, including mixtures thereof.

As used herein, the term “comprising” is intended to mean that the compositions and methods include the recited elements but do not exclude others. “Consisting essentially of” when used to define compositions and methods shall mean excluding other elements of any essential significance to the combination for the intended use. Thus, a composition consisting essentially of the elements as defined herein would not exclude trace contaminants from the isolation and purification method and pharmaceutically acceptable carriers, such as phosphate-buffered saline, preservatives and the like. “Consisting of” shall mean excluding more than trace elements of other ingredients and substantial method steps for administering the compositions of this disclosure. Embodiments defined by each of these transition terms are within the scope of this disclosure.

“Food-grade” means safe for human consumption.

### Polar Oils and Substrates

In the present disclosure, the term polar oil refers to small molecule substances, having molecular weights between about 50 and about 1000 Daltons, that have aqueous solubilities lower than 1 wt %, 1% w/w in isotonic solutions at room temperature; that preferentially dissolves in an oil phase, reflected by a positive logarithm of the octanol/water partition coefficient (positive log P); that have a non-zero polar surface area; that have hydrogen bonding groups, particularly alcohol, carboxylic acid, amines, amides, amino acids or thiol groups. The behavior of the polar oil at the oil/water interface in the presence of surfactants is further described by the bifunctional polar oil model within the HLD framework [12,15]. The bifunctional model indicates that a polar oil can be partly considered to behave as a surfactant with positive characteristic curvature (Cc) and partly as an oil with a negative equivalent alkane carbon number (EACN). The positive Cc value of a polar oil or its negative EACN leads to a positive shift in the HLD of an extracting media composed of a surfactant mixture and a solvent oil. The positive shift in HLD can then produce a final positive HLD associated with the formation of an upper phase microemulsion and an excess aqueous phase. This is the thermodynamic principle guiding the formulation of the dilutable extraction media (DtableEM) disclosed herein.

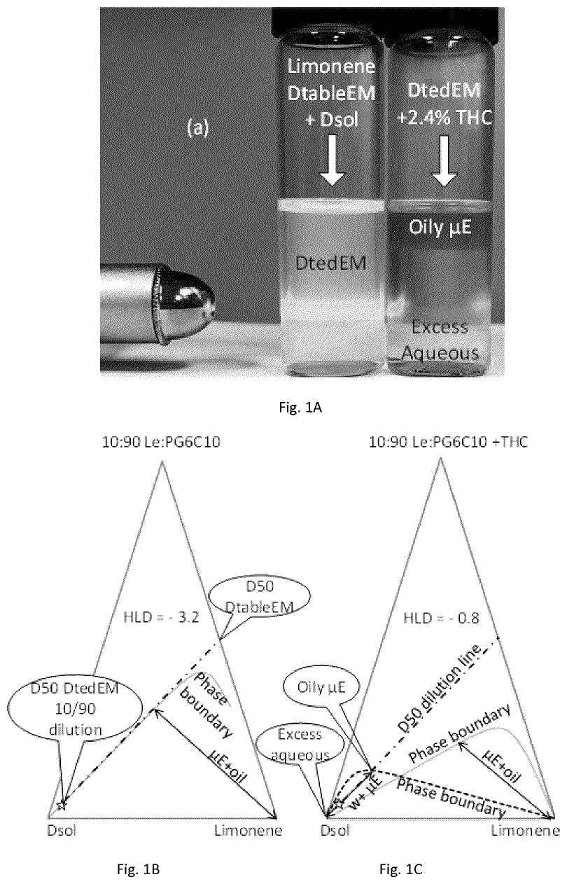

FIGS. 1A-IC illustrate the thermodynamic principle of formulating a DtableEM for the polar oil tetrahydrocannabinol (THC). THC has an MW=314.5 Da, aqueous solubility of 0.0003 wt %, log P=7, polar surface area of 29.5 Å², one hydrogen bonding donor group (—OH) and two hydrogen bond acceptors (two oxygens). The Cc value for THC, obtained following the same procedure disclosed by Nouraei et al. (WO 2022/140843) for cannabidiol (CBD), is +2.7. The composition of the DtableEM in FIGS. 1A-1C is listed in the last row of Table 1 of Example 1. The diluted extraction media (DtedEM) contains 0.5 wt % of lecithin as a surfactant (Le, two C18 tails, MW=750 g/mol, Cc=+5.5), 4.5 wt % polyglycerol caprylate as hydrophilic linker (PG6C10, one C10 tail, MW=590 g/mol, Cc=−3), and 5 wt % limonene as solvent oil (EACN=+6) and diluted with a diluting aqueous solution containing 107 mM of sodium ions, corresponding to an equivalent salinity of S=0.63 gNaCl/100 mL. For this example composition, the mol fraction of Lecithin (Le) in mixture with PG6C10 is (0.5/750)/(0.5/750+4.5/590)=0.08, and by difference, the molar fraction of PG6C10 is 0.92. The Cc of the mixed surfactant+hydrophilic linker system is then 0.08*(+5.5)+0.92*(−3.0)=−2.3. The HLD of the diluted extraction media can be then calculated using Equation 1 at room temperature (T=25° C.), such that HLD=0.13*0.63−0.16*6+ct*(25−25)−2.3=−3.2. The negative value of HLD helps ensure water continuity in dilute solution, which is a required condition to produce microemulsions that are fully dilutable with aqueous solutions. Upon the incorporation of 2.4 wt % THC, simulating the extraction of THC from a biomass substrate, the composition of the surfactant at the interface changes, such that the molar fraction of lecithin becomes (approximately) (0.5/750)/(0.5/750+4.5/590+2.4/314.5)˜0.04. The molar fraction of THC at the interface becomes (2.4/314.5)/(0.5/750+4.5/590+2.4/314.5)˜0.48, and by difference, then the molar fraction of PG6C10 is 1−0.04−0.48=0.48. The mix Cc for the system after extraction becomes 0.04*(+5.5)+0.48*(+2.7)+0.48*(−3)=0.08. With this mix Cc, then the HLD after extraction becomes HLD=0.13*0.63−0.16*6+ct*(25−25)+0.08=−0.8. Although this HLD is still negative, it is close enough to zero to start producing an excess aqueous phase, as illustrated in the ternary phase diagrams shown in FIGS. 1B and 1C, obtained with the net-average curvature (NAC) modeling procedure introduced by Nouraei et al. [14]. The concept of phase separation induced by the extraction of polar oil illustrated in FIG. 1 is demonstrated in Example 1, where 80% of the total THC present in a Cannabis Indica biomass source was extracted into a separate oily surfactant extract phase (OSEP) containing 4.3 wt % of THC. The OSEP of Example 1, similarly to the microemulsion produced in FIG. 1 in the presence of THC, still contains some water, most of the surfactant, and all of the polar oil extracted. No THC could be detected in the excess aqueous phase of Example 1 nor the excess aqueous phase of the system containing THC in FIG. 1.

Examples 3, 5, 7, 9, 13 and 15 show additional embodiments for THC extraction from Cannabis Indica flowers using lecithin as a surfactant, and hydrophilic linker, PG6C10 or a mixture of PG6C10 and PG10C10, using different solvent oil or oil mixtures, and with different solvent oil content. In all these cases, an excess aqueous phase was formed with non-detectable levels of THC and with a top oily surfactant extract phase (OSEP) containing between 72 and 84% of the THC in the cannabis flowers. Example 13 presents an embodiment where eugenol, another polar oil, was extracted from the buds of Syzygium aromaticum, where the same dilutable extracting media of Example 3 was used, and an OSEP was obtained containing 71% of the clove, along with an excess aqueous phase.

Polar oils that can be extracted using the compositions and procedures described herein can be used in a variety of applications, including but not limited to, nutritional or nutraceutical applications in humans and animals; pharmaceutically active ingredients (API), including cannabinoids; biocides or biostatic (preservatives) compounds in food, pharmaceutical, cosmetic, antiseptic, disinfectant, and agrochemical applications. The list of polar oil substances that can be extracted using the compositions and methods of the present disclosure includes, but is not limited to, poorly soluble alcohols including Acetyldigoxin (from Digitalis lanata), Aesculetin (from Frazinus rhychophylla), Agrimophol (from Agrimonia supatoria), Andrographolide (from Andrographis paniculata), Anisodamine (from: Anisodus tanguticus), Anisodine (from Anisodus tanguticus), Asiaticoside (from Centella asiatica), beta-Aescin (from Aesculus hippocastanum), Atropine (from Atropa belladonna), Bergenin (from Ardisia japonica), Borneol (from Rosmarinus officinalis and other plants), Camptothecin (from Camptotheca acuminata), Capsaicin (from Capsicum species), Catechin (from Potentilla fragarioides), Convallatoxin (from Convallaria majalis), Curcumin (from Curcuma longa), Cynarin (from Cynara scolymus), Danthron (from Cassia species), Deslanoside (from Digitalis lanata), Etoposide (from Podophyllum peltatum), Hesperidin (from Citrus species), Lapachol (from Tabebuia species), Menthol (from Mentha species), Methyl salicylate (from Gaultheria procumbens), Neoandrographolide (from Andrographis paniculata), Nordihydroguaiaretic acid (from Larrea divaricata), Phyllodulcin (from Hydrangea macrophylla), Podophyllotoxin (from Podophyllum peltatum), Rutin (from Citrus species), Silymarin (from Silybum marianum), Taxol (from Taxus brevifolia), Teniposide (from Podophyllum peltatum), Tetrahydrocannabinol (THC, from Cannabis species), Cannabidiol (CBD, from Cannabis species), Thymol (from Thymus vulgaris), Yuanhuadine (from Daphne genkwa), phytosterols (from various plant seeds and cereals), Eugenol (from Syzygium aromaticum), Terpineol (from various plants), retinol (from liver and other animal tissues), Vanillin (from Vanilla planifolia), Cinnamyl alcohol (from Cinnamomum verum), Farnesol (from Vachellia farnesiana), Nerolidol (from Brassavola nodosa), Anisaldehyde (from Pimpinella anisum), Linalool (from Ocimum basilicum and other plants), Geraniol (from Rosa species and other plant sources), among other alcohols. Fatty acids are other examples of candidate polar oil, including Betulinic acid (from Betula alba) and Cinnamic acid (from Cinnamomum verum). Organic amines are other candidate polar oils, including Ajmalicine (from Rauvolfia sepentina), Anabasine (from Anabasis sphylla), Colchicine (from Colchicum autumnale), Demecolcine (from Colchicum autumnale), Deserpidine (from Rauvolfia canescens), Emetine (from Cephaelis ipecacuanha), Glaucine (from Glaucium flavum), Hydrastine (from Hydrastis canadensis), Lobeline (from Lobelia inflata), Noscapine (from Papaver somniferum), Pseudoephedrine (from Ephedra sinica), Quinidine (from Cinchona ledgeriana), Quinine (from Cinchona ledgeriana), Rescinnamine (from Rauvolfia serpentina), Scopolamine (from Datura species), Sparteine (from Cytisus scoparius), Tetrahydropalmatine (from Corydalis ambigua), Tetrandrine (from Stephania tetrandra), Theobromine (from Theobroma cacao), Topotecan (from Camptotheca acuminata), Tubocurarine (from Chondodendron tomentosum), Vinblastine (from Catharanthus roseus), Vasicine (from Vinca minor), Yohimbine (from Pausinystalia yohimbe).

### Extraction Media

In this document, the term Dilutable Extraction Media (DtableEM) is defined as a single-phase mixture composed of (a) 0-10% of a surfactant having a hydrocarbon tail group with 12 or more carbons (C12+), (b) a hydrophilic linker having a hydrocarbon tail group with 6 to 10 carbons (C6-C10), and (c) a hydrocarbon (excluding linear alkanes) solvent oil that, upon dilution with an aqueous diluting solution (Dsol), form microemulsions with sizes often ranging in the 1-200 nm range, without excess aqueous and oil phases, and without the formation of highly viscous (>1000 Cp) liquid crystals.

In one embodiment, a dilutable extraction media (DtableEM) composition for a two-phase extraction of one or more polar oil active compounds from biomass substrates comprises: (a) 0-10% of a surfactant, having at least one hydrocarbon group with 12 to 18 carbon atoms; (b) a hydrophilic linker, having one hydrocarbon group with 6 to 10 carbon atoms; and (c) a solvent oil, excluding linear alkanes, having a boiling point of no more than 100° C., i.e., 100° C. or under 100° C.

In one embodiment, the DtableEM of the present disclosure includes 0% of the surfactant.

The DtedEM plays a dual role in the disclosed extraction process, first as a delivery system for the solvent oil to the oil bodies in the biomass substrate, and second as a way of capturing polar oils that can segregate near the hydrophilic linker at the interface, following the combined linker effect. The solvent oil can dissolve solid or highly viscous polar oils into a liquid solution, or reduce the viscosity of viscous polar oils, allowing the incorporation of the extracted polar oils into microemulsions that eventually become the OSEP at the end of the extraction process.

A property of the disclosed DtableEM compositions of the present disclosure is that the uptake of the polar oil results in the formation of the OSEP and an excess aqueous phase. The principle of this phenomenon is illustrated in FIG. 1A-1C where a Lecithin (surfactant)-polyglycerol caprylate (PG6C10) (hydrophilic linker)-limonene (solvent oil) DTableEM, diluted 10/90 with an aqueous diluting solution (Dsol) containing 107 mM of equivalent sodium is initially a single-phase microemulsion, but upon the introduction of tetrahydrocannabinol (THC) as an example polar oil, this produces an upper phase microemulsion containing THC and an excess aqueous phase with undetectable levels of THC. The upper phase microemulsion is representative of the OSEP produced during the extraction process. The formation of the excess aqueous phase is a desirable feature because it allows for water-soluble or dispersible contaminants to be removed from the extracted polar oil.

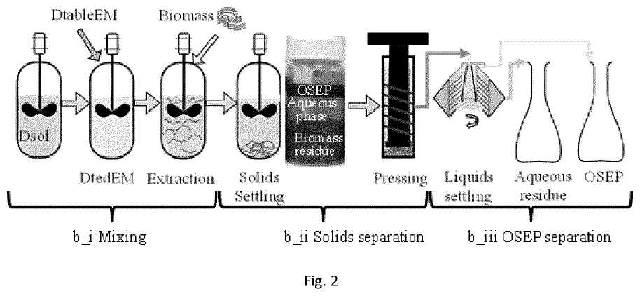

The importance of the combination of the surfactant, hydrophilic linker, and the solvent oil in the DtableEM is further exemplified when comparing the 72-84% THC extraction efficiencies obtained in Examples 1, 3, 5, 7,9, 15, 16, 17 and 18 with the THC extraction efficiencies obtained with solvent oil only, cyclohexane (having a boiling point of 80° C.), in Example 11, with the surfactant-hydrophilic linker only in Example 12 and with the hydrophilic linker, and the solvent oil in Example 14. When using cyclohexane-only as extraction media, 20 parts of cyclohexane had to be used to extract 1 part of ground cannabis flowers to obtain an extraction efficiency of 84% THC extraction. The extractions in Examples 1, 3, 5, 7 and 9 were obtained with a ratio of 2 parts of DtableEM and 18 parts of Dsol. In Example 7, half of the DtableEM was cyclohexane, therefore in Example 7, only one part of cyclohexane was used to extract one part of ground cannabis flower to obtain 72% extraction of THC. The 20-fold reduction in solvent use with the DtableEM exemplifies the advantage of the disclosed DtableEM over solvent-only extraction. An attempt was made to extract 1 gram of cannabis flower with 1 gram of solvent-only, but no liquid could be collected from such a trial. This observation illustrates another advantage of the two-phase post-extraction feature of the disclosed DtableEM. The residual biomass is left surrounded by an aqueous media, as illustrated in the picture of FIG. 2, and not by the original extraction media. As the OSEP separates to the top of the extraction vessel, it completely disengages from the porous structure of the biomass. It must be noted that using a surfactant is desirable but not required. Example 14 shows that without lecithin (surfactant), one can still obtain 72% THC extraction with DtableEM.

Examples 1, 3, 5, 7, and 9 illustrate another advantageous feature of the disclosed DtableEM composition, in that the ratio of DtableEM to polar oil is smaller than the values cited earlier for other extraction methods and extraction media. In the cited examples, 1 part (by mass) of cannabis flower, in itself containing 0.18 parts of the polar oil THC, was extracted with 20 parts of DtedEM that in itself contained 2 parts of DtableEM. Thus, the ratio of DtableEM to polar oil used was 2/0.18=11.1, substantially lower than the ranges of 16 to 250 observed with other extraction methods. Lower extraction media/polar oil ratios are desirable to reduce the cost associated with the extraction media and to increase the concentration of the polar oil in the extracted phase. The biomass to DtedEM (solid to liquid ratio or SLR) can range from 1:6 to 1:60. Example 15 shows that while the extraction efficiency reduces to 64% at SLR 1:10, this means a DtableEM to polar oil of 1/0.21=4.8

The role of the surfactant is to promote the segregation of the hydrophilic linker and the polar oil at the interface, following the so-called combined linker effect. The hydrophilic headgroup of the C12+ surfactant can be anionic, including C12+ sulfates, sulfonates, phosphates, phosphonates, carboxylates, sulfosuccinates; the hydrophilic group can also be nonionic, including carboxylic acids, alpha-hydroxy acids, esters of polyhydric alcohols, or glucosides, secondary ethoxylated alcohols, pyrrolidones; the hydrophilic group can also be cationic, including amines, quaternary ammonium salts, amine oxides; the hydrophilic group can also be zwitterionic, including alkyl aminopropionic acids, betaines, sulfobetaines, phosphatidylcholines. In one embodiment, the compositions include the use of the zwitterionic surfactant lecithin. Lecithin has a generally recognized as safe (GRAS) status that could make some of the extracts suitable for food and pharmaceutical use. The term lecithin (including lysolecithin) refers to compounds or mixtures of phosphatidylcholines and other lipids and containing at least 50% w/w of a mixture of mono- and di-alkyl phosphatidylcholines, phosphatidylethanolamines, phosphatidylinositols and phosphatidylglycerols that can be obtained from animal (e.g., eggs), vegetable (e.g., soybean) sources or obtained through chemical synthesis. Preferred compositions are comprised of lecithin obtained from vegetable sources. The term “lecithin” also includes synthetic-based phospholipid compounds. Non-limiting examples of synthetic-based phospholipid compounds that can be used as the surfactant include alkyl amidopropyl PG-Dimonium Chloride Phosphate.

Hydrophilic linkers are amphiphilic, surfactant-like compounds containing 6 to 10 carbon atoms in their alkyl group having a negative characteristic curvature (Cc). The hydrophilic group in these linkers can be anionic (sulfates, sulfonates, phosphates, phosphonates, carboxylates, sulfosuccinates) such as octanoates, octyl sulfonates, dibutyl sulfosuccinates; nonionic (carboxylic acids, alpha-hydroxy acids, esters of polyhydric alcohols, or glucosides, secondary ethoxylated alcohols, pyrrolidones) such as octanoic acid, 2-hydroxyoctanoic acid, hexyl and octyl polyglucosides, octyl pyrrolidone; cationic (amines, quaternary ammonium salts, amine oxides) such as octylamine; or zwitterionic (alkyl aminopropionic acids, betaines, sulfobetaines, phosphatidylcholines) such as octyl sulfobetaine, dibutyryl phosphatidylcholine, among others. The short tail length of hydrophilic linkers, ranging between 6 and 10 carbons, has been found to reduce the interfacial rigidity of surfactant-oil-water (SOW) systems, including microemulsions, facilitating a quick solubilization process [16]. Examples 1 thru 10,13 and 14 illustrate the formulation and use of DtableEM comprising polyglycerol-6-caprylate (Dermofeel® G6CY, also noted as PG6C10) as a hydrophilic linker.

Example 12 illustrates the role of the solvent oil in the composition of the DtableEM. In example 12, the DtableEM is only comprised of lecithin as surfactant and PG6C10 as hydrophilic linker, without solvent oil. When this solvent-free composition was used to extract THC, only a total THC extraction efficiency of 12% was obtained. The solvent oil facilitates the dissolution and extraction of the polar oil solute in the DtableEM. The presence of the solvent oil also hinders the formation of insoluble or slow-dissolving liquid crystals. The solvent oil should not be a linear alkane, as it was discovered that these molecules induce the precipitation of hydrophilic linkers in the DtableEM. Preferred solvent oils include cycloalkanes such as cyclohexane (with a boiling point of 80° C.), branched alkanes, alkyl esters of fatty acids such as isopropyl myristate, ethyl caprate, methyl oleate, ethyl oleate; terpenes such as limonene, pinene; and mixtures of with mono- di - and triglycerides used as cosolvents. In one embodiment, the solvent oil has a boiling point of no more than 100° C.

The diluting solution (Dsol) can be water (including mineral water, tap water and distilled water) or an aqueous solution containing electrolytes, anionic, nonionic or zwitterionic surfactants, or water-soluble polymers at a concentration of 1 wt % or less. Examples 1, 3, 5, 7, 8, 9 and 14 use a solution of mineral water containing sodium chloride as electrolyte and surfactants sodium taurocholate and lecithin at concentrations lower than 1 wt %. Example 13, 15, 16, 17, 18 and 19 use mineral water without salts, surfactants, or polymers as the diluting solution. The dilution ratio DtableEM:Dsol could range between 50:50 and 5:95. In this range, it is expected that the resulting mixture, the diluted extraction media, or DtedEM, would have a viscosity lower than 1000 Cp and a drop size, measured via dynamic light scattering, of less than 200 nm, and preferably less than 100 nm as illustrated in Examples 1, 3, 5, 7, 9, 15 and 18. Under those conditions of viscosity and sizes, it is expected that the microemulsion drops in the DtedEM can penetrate the tissues of the substrate. This is the principle cited for the penetration of nanodrops through epithelial tissues [17].

### Extraction Process

The polar oil extraction processes disclosed herein are comprised of: (b_i) mixing a DtableEM of the present disclosure, a diluting solution (Dsol), and a biomass substrate; (b_ii) separation of the solid residual biomass; (b_iii) separation of the oily surfactant extract phase (OSEP) containing one or more target polar oils. In embodiments, the steps of separating the solid residual biomass and the Dsol can be accomplished in one common step.

The purpose of the mixing step b_i is twofold, first to facilitate the dilution of the DtableEM with the Dsol and form the DtedEM; and second, to facilitate the penetration of the DtedEM into the biomass substrate containing the one or more target polar oils. The substrate biomass can be a dry or wet biomass. It is well known in the field that the best extraction can be obtained with substrates that have undergone some form of pre-treatment, such as trimming or grinding [1]. Such pre-treatments of the biomass substrate reduce the length that the DtableEM must penetrate the biomass to reach the target polar oil. Furthermore, biomass pre-treatments can also help break the protective structure of the oil bodies. To facilitate the extraction process and shorten the extraction time, it is desirable for the biomass substrate of b_i to be cut, crushed, minced, or ground ahead of the mixing step. Pre-drying or roasting of the biomass to be extracted may be a desirable pre-extraction step for some oils, but it is not a necessary step for the disclosed technology as the affinity of the microemulsions for oily and aqueous environments will enable the permeation of wet biomass substrates. To minimize the risk of undesirable residues in the extract, the biomass substrate should be washed ahead of the extraction process, following the appropriate protocols required for the potential residues. The mixing conditions involve, at a minimum, the use of a blade mixer with a mixing speed ranging between 100 and 3000 rpm, adjusted to make sure that the entire biomass is suspended in the mixing media. Higher mixing speeds are suitable for low viscosities (<10 Cp), and lower mixing speeds are desirable for systems with larger viscosities. The principle governing the mixing intensity is the capillary number obtained during the mixing process [18]. This capillary number is proportional to the product of the mixing speed, the particle size, and the viscosity of the extracting media. Systems with larger substrate particle size and viscosity require lower mixing speed. The mixing time can be enough to accomplish the necessary dilution of the DTableEM, to accomplish the penetration of the DtedEM into the substrate, and to shear off any extracted oil from the surface of the substrate. For systems that produce low interfacial tensions (<0.1 mN/m), a minimum of 5 minutes is necessary to shear-off low viscosity oily phases from solid substrates in a continuous aqueous phase [18], but larger times, in the scale of hours, are required for more viscous oily phases. The embodiments include mixing times ranging from 5 minutes to 3 hours. One embodiment includes extraction times between 10 minutes and 60 minutes. The mass ratio of DtableEM/Dsol can range from 50/50 to 5/95, and it is adjusted to ensure that there is enough liquid to create a biomass slurry and produce a separate the oily surfactant phase OSEP. One embodiment includes dilution ratios ranging between 20/80 and 10/90. In this specific range, the viscosities tend to be less than 10 Cp, and the particle size tends to be 100 nm or less, as evidenced in the examples. The biomass:DtedEM mass ratio can be adjusted between 1:5 and 1:50 to ensure that the biomass slurry can be fully suspended by the blade mixer and that the OSEP can fully disengage from the biomass. The preferred embodiments use a biomass:DtedEM mass ratio ranging from 1:10 to 1:20. The temperature of the mixing step b_i is preferably room temperature, particularly ranging from 20° C. to 30° C., enabling the use of a mixing device without heating elements. In systems with polar oils with melting points higher than room temperature, or with viscosities lager than 100 Cp at room temperature, the temperature of the mixing step can be increased to match the melting point of the polar oil or enough to reduce the viscosity of the oily surfactant extract phase (OSEP) to 100 Cp or less, to facilitate the removal of the oily phase from the substrate. To prevent flashing of the DtedEM, the temperature of the mixing step should be kept 10 degrees lower than the lowest value between the boiling point of the solvent oil and the boiling point of water. The order of mixing in step b_i does not affect the ultimate extraction performance of the process because of the thermodynamic equilibrium associated with the formation of microemulsions (diluted extraction media).

The separation of the residual biomass in b_ii involves separation of the OSEP from the excess aqueous phase and the residual solids (including biomass residue) and straining or filtration to remove the residual solids. In one embodiment, the separation of the OSEP from the excess aqueous phase is done with gravitational forces, pressure driven forces, or with filters, or with any other suitable method. The gravitational separation conditions depend partly on the time required for the drops of the OSEP to cream to the top layer of the separated microemulsion (OSEP) phase and partly on the time required to detach OSEP drops trapped in the biomass matrix. The product of the gravitational acceleration times the creaming time follows Stoke's law for settling velocity equation whereby the product is proportional to the viscosity of the DtedEM, proportional to the inverse of the square value of the drop size, and proportional to the inverse of the difference between the density of the OSEP drops and the excess aqueous phase. The gravitational acceleration can range from 1 to 10,000 times earth's gravity. The OSEP drops trapped in the porous matrix of the biomass can be disengaged from the matrix if the ratio between the gravitational forces pulling the drop and the interfacial tension forces trapping the drop in the biomass is greater than 1. This ratio is expressed by the Bond number, which is proportional to the difference in density between the excess water and the OSEP, to the gravitational acceleration, to the drop size square, and the inverse of the interfacial tension [19]. Larger Bond numbers would guarantee improved separation of the OSEP, which is achieved with a higher acceleration of gravity provided by a continuous or batch centrifuge. The separation time under gravitational forces can vary from 5 minutes to 12 hours to ensure complete disengagement of drops of OSEP that might be trapped in the residual biomass. In some embodiments, a combination of the high gravitational acceleration of 500 to 10,000×G for up to 30 minutes with ambient gravitational acceleration (1×G) for up to 12 hours is used to maximize the separation of the OSEP into atop liquid layer. To remove the residual biomass, the process could include using a filter press (a pressure-driven process), a meshed basket, a sieved spoon or ladle, a basket centrifuge or spinner (a gravity-driven process), or any other device that can facilitate the drainage of the liquid while retaining the solid biomass residue. In some embodiments, the extraction and separation of the biomass can be combined using a continuous expeller press (a pressure-driven process). The use of the expeller press also enables turning the batch extraction process into a continuous process.

The separation of the top OSEP phase is accomplished in Step b_iii. The separation of the top OSEP from the bottom excess aqueous phases is accomplished via gravitational forces, and similarly to step bii, the creaming of OSEP drops to the top OSEP layer is described by Stoke's settling equation. Therefore, the product of gravitational acceleration times separation time increases with the viscosity of the excess aqueous solution, and it is larger for smaller drops and larger settling distances. Centrifugal accelerations of up to 10,000 times earth's gravity (10,000×G) can be used in this step using batch or continuous disk centrifuges. Larger centrifugal accelerations are to be accompanied by short centrifugation times such that the product of acceleration times separation time is between 100 and 10,000×G*minutes. The preferred embodiments employ 100 to 10,000×G of centrifugal acceleration and 3 to 30 minutes of separation time. For viscous phases, separation times of up to 3 hours are expected.

In embodiments, step b_iii can be conducted before step b_ii, and in some cases in parallel with b_ii when using a solid-liquid-liquid centrifuge or other separators that can undertake the combined separation process.

The association of the extracted polar oil with the surfactant, the hydrophilic linker, and the solvent oil in the OSEP can produce dilute solutions of the extracted polar oil. For uses in food, pharmaceutical or cosmetic applications, dilute solutions might not have the required activity for the intended application. The purpose of the refinement processes (embodiment c) is to increase the concentration of the extracted polar oil in a refined extract (RefEx). The main components of the OSEP include the extracted polar oil, the surfactant, the hydrophilic linker, the solvent oil and water that is solubilized in the OSEP.

Examples 1, 3, 5, 7, 9, 13, 15, 16, 17 and 18 illustrate that applying the separation steps b_i through b_iii can produce extraction efficiencies ranging from 72% to 84% of the original polar oil using different DtableEM, different Dsol, and different polar oils and substrates. It is known to those skilled in the art that the extraction efficiency can be further improved using multiple sequential extractions [20]. In other embodiments, the steps b_i through b_iii can be applied in a multi-stage approach to improve the extraction of the polar oil further. The application of such a multi-stage approach can include the use of moving bed leaching units, or Bollman extractor units, or Rotocel extraction units, or contactor/settlers units in series, or fixed bed extractors in series, or a Hildebrant screw-conveyor extractor, or a set of screw presses in series, among others.

### Refinement Process

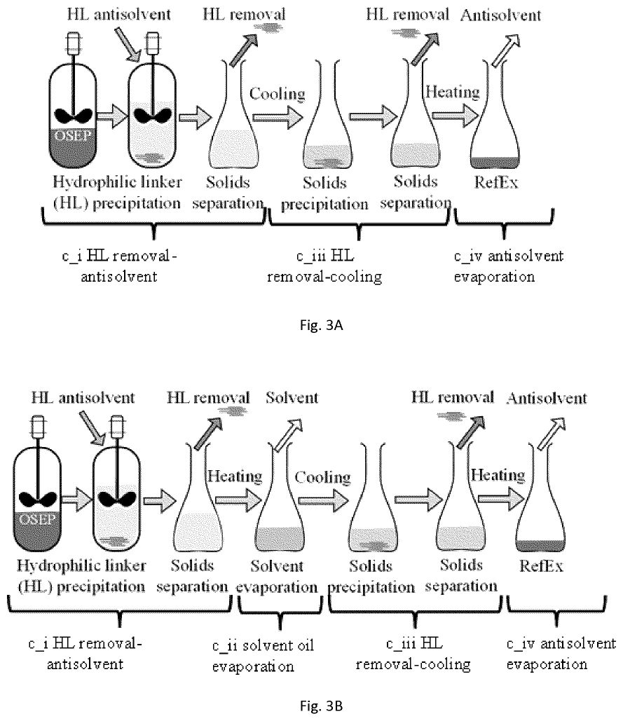

The objective of the refinement process is to increase the concentration of the extracted polar oil via the removal of one or more of the components of the oily surfactant extract phase (OSEP) obtained at the end of the extraction stage. This more concentrated solution of the polar oil is referred to as the refined extract or RefEx. The components that can be removed with the steps described below include the solubilized water, the hydrophilic linker, and the solvent oil. Depending on the target product of the refinement process, the separation stages can aim at the removal of one or more of the aforementioned components. The description below involves a combination of procedures that can be used to remove water, hydrophilic linker, and solvent oil. FIGS. 3A and 3B illustrate two versions of the more general refinement process.

The main challenge when purifying the extracted polar oil in the OSEP is that polar oils have a great affinity for the surfactant since the polar and yet oil-like nature of the hydrocarbon tail of the surfactant is a good match for the amphiphilic nature of polar oils. This affinity is evidenced by the tendency of polar oils to segregate at the palisade layer of surfactant micelles and microemulsions [12,21]. Other than the affinity for the surfactant, the affinity of the polar oil for the hydrophilic linker and the potential to establish a combined linker self-assembly [10] is yet another challenge that hinders the purification of the polar oil present in the OSEP phase. The first step in the refinement process step (c_i) has the objective of removing part or all of the hydrophilic linker via precipitation. The precipitation of hydrophilic linkers is induced by the addition of linear C5+ alkanes. This precipitation phenomenon shown in the examples and included as a part of the separation steps is surprising because, in many other formulations that do not use polyglycerol-based hydrophilic linkers, C5+ alkanes can be used without causing precipitation [10]. Therefore, the preferred hydrophilic linkers in the DtableEM for systems that will undergo step c_i are C6-C10 polyglycerol esters of fatty acids. The C5+ alkanes act as hydrophilic linker antisolvents and are referred to as such in the rest of this description. Experimentally, it was observed that the minimum ratio antisolvent/OSEP to observe precipitation is 0.5/1 parts (by mass) when using n-heptane as antisolvent. Using C5 (n-pentane) and C6 (n-hexane) as antisolvent requires higher minimum ratios, close to 1:1. Increasing the antisolvent/OSEP ratio increased the mass of precipitate, and the maximum mass of linker precipitated was obtained using a 1.2/1 antisolvent/OSEP mass ratio. The preferred antisolvents are C6 and C7 alkanes, including mixtures of n-alkanes and isomers. Alkanes of C8 or higher carbon number alkanes are also possible as long as they can still be later removed from the refined extract via evaporation or freezing. To guarantee adequate mixing, step c_i is best conducted using a blade mixer with a mixing speed ranging between 100 and 500 rpm, adjusted to make sure that there is enough mixing between the OSEP and the antisolvent while avoiding breaking up and dispersing the precipitated phase. The mixing time ranges from 5 minutes to 5 hours, expecting longer mixing times for more viscous OSEPs (>100 Cp). This step is preferentially conducted at room temperature, but it could be conducted at a higher temperature, especially if the viscosity of the OSEP is greater than 100 Cp. Step c_i and step c_iii (hydrophilic linker and water removal via freezing) can be combined by conducting the mixing at low temperature, just above the freezing point of the solvent oil to diminish the migration of not-desirable polar oils or heavy lipids such chlorophyl and waxes into OSEP. The extraction could also be done using a pack-bed reactor in which the biomass is packed in filter bag and DtedEM circulates around that. Following mixing, the mixer is stopped, and the solids are left to settle for 5 min to 5 hours, expecting longer settling times for viscous OSEPs (>100 Cp). The preferred settling time is between 30 minutes and 1 hour. The solid-liquid separation can be completed either by decantation of the liquid, via press filtration, centrifugal separation, basket or sieve straining. For reformulated OSEP applications into a self-microemulsifying delivery system (SMEDDS), step c_i is not required as the hydrophilic linker is part of the delivery system.

The objective of step (c_ii) is to evaporate water, and in some cases, the solvent oil. Step c_ii takes place in an evaporator, which could be a bladed mixer equipped with a heating coil or a heating jacket, a shell and tube reboiler or thermosyphon, or a spray dryer. The evaporation process is partly limited by the rate of heat transfer and partly by the difference in the vapor pressure of the evaporating component at the temperature of the evaporator and the partial pressure of the component in the gas phase. To aid in the evaporation process, introducing agitation in the liquid phase is a desirable feature of the evaporator. Similarly, a high heat transfer area provided by coils or heating jackets is also desirable in the evaporator. Extraction under forced gas flow such as that obtained in a spray dryer is also desirable. The evaporation temperature should be equivalent to, or at most 10 Celsius above, the target component boiling point (water or solvent oil). In some embodiments, step c_ii could be further combined with the evaporation of the antisolvent (step c_iv) by setting the boiling temperature equivalent to, or at most 10 Celsius above, the boiling point of the hydrophilic linker antisolvent. In some embodiments, the goal of the refinement process is to produce a refined extract (RefEX) meant to be used as a solventless SMEDDS base, containing the extracted polar oil, the surfactant and the hydrophilic linker. To produce this RefEX-solventless SMEDDS base, step c_ii is the only refinement step, and the temperature of the evaporator is set equivalent to or at most 10 Celsius above the largest boiling point between that of the water and the solvent oil. The use of DtableEM comprising solvent oils with boiling points of 100° C. or lower, during extraction, is specially advantageous towards producing RefEX-solventless SMEDDS as it facilitates the evaporation of the solvent, in particular when using step c_ii as the only refinement step. In other embodiments, the goal of the refinement process is to produce a refined extract (RefEX) meant to be used as a SMEDDS base containing the extracted polar oil, surfactant, hydrophilic linker, and solvent oil. To produce this RefEX-SMEDDS base, step c_ii is the only refinement step, and the temperature of the evaporator is set to or at most 10 Celsius above the boiling point of water, provided that the solvent oil selected has a boiling point of at least 10 Celsius above that of water. The evaporator can be operated at atmospheric pressure, under vacuum or pressurized conditions. The preferred method of extraction uses evaporator pressures between half and 10 times atmospheric pressure.

The objective of step c_iii is to achieve additional removal of hydrophilic linker and water that may be left over from c_i by reducing the temperature of the extract low enough to further reduce the solubility of the hydrophilic linker in the presence of the antisolvent. Step c_iii can take place in a bladed mixer equipped with a heat exchanger coil or a heat exchanger jacket, or in a shell and tube heat exchanger, or a fluidized suspension crystallizer. The preferred method of crystallization involves mild forced convection heat transfer to accelerate the cooling process and prevent the formation of crystal deposits in the crystallizer device. The crystallization temperature should be equivalent to, or at most 10 Celsius below, the largest value between the melting point of the solvent oil, the water, or the antisolvent (if present). Having crystallization temperatures lower than the indicated range can produce gelification of the entire system. The crystallization time can vary from 30 min to 12 hours, expecting longer crystallization times for viscous systems (>100 Cp). Step c_iii also involves a method for removing the precipitated solids through decantation of the liquid, press filtration, centrifugal separation, or straining.

The purpose of step c_iv is to remove any antisolvent added in step c_i via evaporation. This evaporation step takes place in an evaporator, which could be a bladed mixer equipped with a heating coil or a heating jacket, a shell and tube reboiler or thermosyphon, or a spray dryer. A desirable feature of the evaporator is to incorporate some form of agitation in the liquid phase to aid in the heat transfer and avoid the formation of hot spots in the evaporator chamber. Another desirable feature for evaporators is a high heat transfer area provided by coils or heating jackets. Extraction under forced gas flow such as that obtained in a spray dryer is also desirable. The evaporation temperature should be equivalent to, or at most 10 Celsius above, the boiling point of the antisolvent. The evaporator can be operated at atmospheric pressure, under vacuum or pressurized conditions. The preferred method of extraction uses evaporator pressures between half and 10 times atmospheric pressure.

Examples 2, 4, and 6 illustrate the use of the refinement train that does not remove the solvent oil as depicted in FIG. 3a, including stages c_i, c_iii, and c_iv. Examples 8 and 10 illustrate the use of the refinement train that includes the removal of the solvent oil as depicted in FIG. 3b, including stages c_i, c_ii, c_iii, and c_iv. As shown in these examples, the concentration of the extracted polar oil in the OSEP can be increased by a factor of 2 when using the separation train of FIG. 3a and by a factor of 4 when using the separation train of FIG. 3b. It is known to those skilled in the art that the concentration of extracts can be further increased using additional refinement processes that may include the use of liquid chromatography or membrane separation steps.

The advantages of the composition and processes disclosed include producing a separate excess aqueous phase during extraction that can be used to remove part of water-soluble or water-dispersible undesirable components, low ratios of dilutable extraction media to the extracted oil, high concentrations of the extracted oil in the OSEP, and refinement methods that can increase the concentration of the extracted oil between 2 and 4 times.

Further purification of the crude extract could be accomplished using conventional separation techniques such as distillation or flash chromatography.

The following examples are intended to illustrate but not limit the disclosure and form part of the description.

### EXAMPLES

### Example 1. Cannabinoid Extraction into an Oily Surfactant Extracted Phase (OSEP) Using Lecithin-PG6 Caprylate-Limonene Dilutable Extracting Media (DtableEM)

The dilutable extracting media (DtableEM) was produced by mixing 50 parts (by mass) of limonene (technical grade, EACN=+6), used as solvent oil, and 50 parts of a lecithin-linker mixture. The lecithin-linker mixture was prepared by mixing 10 parts (by mass) of soybean-extracted lecithin (Cc=+5.5) with 90 parts of the hydrophilic linker polyglyceryl-6-caprylate (PG6C10, Dermofeel® G6CY, Cc=−3) using a vortex-mixer.

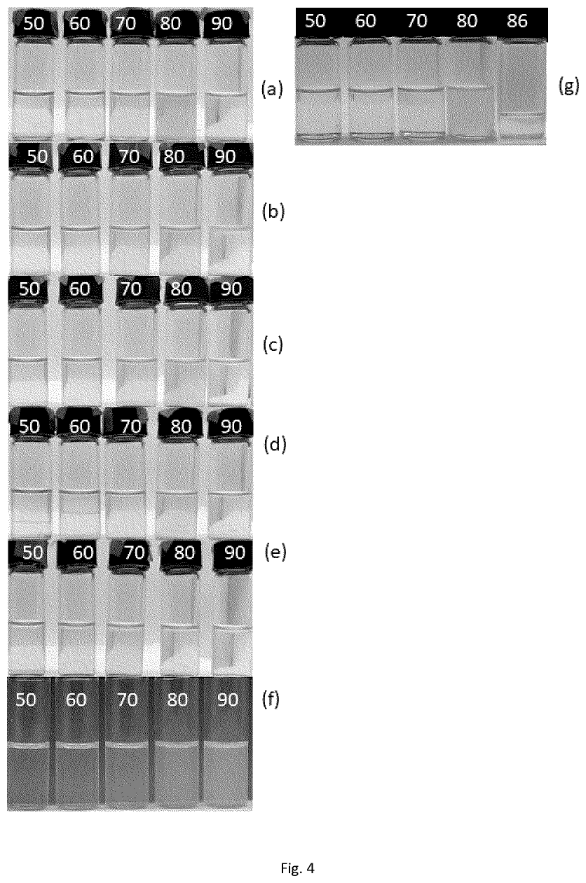

Following the procedure illustrated in FIG. 2, the DtableEM was mixed with a diluting solution (Dsol) containing 100 mM sodium chloride, 2 mM lecithin and 7 mM sodium taurocholate in spring water to produce the diluted extraction media (DtedEM). Row (a) of FIG. 4 shows pictures of DtedEMs obtained with different levels of Dsol. These DtedEM were vortex-mixed and then left to equilibrate for two hours to detect the presence of multiphase systems. The viscosity and hydrodynamic diameter of the DtedEM produced with 10/90 DtableEM/Dsol ratio were measured using a Gilmont Instruments falling ball viscometer and a Brookhaven Instruments BI-90plus dynamic light scattering instrument, respectively. Table 1 summarizes the phase behavior obtained using different dilution ratios. The DtedEM produced with 10/90 DtableEM/Dsol ratio was used to conduct the extraction procedure. The biomass used in this example was Cannabis Indica, 6 grams of the flowers purchased from a local licensed distributor. The flowers were ground using mortar and pestle to a size of 4 mm. The 6 grams of ground flowers were mixed with 120 grams of the 10/90 DtedEM in a 250 mL beaker. A Kacsoo (Zenroe) electric overhead stirrer mixer equipped with a 55 mm stainless steel mixing paddle was used to mix the ground flower suspension at 400 rpm for 60 minutes. After that time, the extract was centrifuged for 30 minutes at 3750 rpm (3210Gs), using a Beckman Allegra 6R centrifuge, and then it was left to gravity-settle for 12 hours, allowing for any oily surfactant phase drops trapped in the biomass to be released (solids settling in FIG. 2). After the solids were settled, the system was press-filtered to remove the solids residue, and the two-phase liquid portion was then centrifuged at 3750 rpm (3210Gs) for 30 min (liquid settling in FIG. 2). The top oily surfactant extract phase (OSEP) was then decanted from the top, and the excess aqueous residue was gravity drained for disposal. The wet biomass was left to dry in the air for further analysis.

The cannabinoid content in the original plant and the dried extracted solids was determined via HPLC by a Cannabis-authorized testing laboratory using a proprietary protocol involving the use of a C18 column, mobile phase—gradient of Mobile Phase A and B (27/73 V/V %). A: ammonium formate/water (441.39 mg in 1 L) and B: 1.00 mL of formic acid in acetonitrile to total volume of 1000 mL. The initial and final tetrahydrocannabinol (THC) and tetrahydrocannabinolic acid (THC-A) content in the ground flowers is presented in Table 2, along with the extraction efficiency calculated based on these values.

TABLE 1
Composition and number of phases obtained upon dilution of a lecithin-
PG6-caprylate-limonene DtableEM. Columns (a) through (d) represent
the weight percentage of (a) lecithin; (b) hydrophilic linker PG6C10;
(c) Dsol; (d) solvent oil, limonene. The DtableEM system corresponds
to a dilution line D50, containing 50 parts of surfactant +
linkers mixture for every 50 parts of solvent oil (limonene).

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 5 | 45 | 0 | 50 | 1 | | |
| 50/50 | 2.5 | 22.5 | 50 | 25 | 1 | 30 | |
| 40/60 | 2 | 18 | 60 | 20 | 1 | | |
| 30/70 | 1.5 | 13.5 | 70 | 15 | 1 | 22 | |
| 20/80 | 1.0 | 9.0 | 80 | 10 | 1 | | |
| 10/90 | 0.5 | 4.5 | 90 | 5 | 1 | 3.6 | 51 |

TABLE 2
Extraction performance of THC into an oily surfactant extract
phase (OSEP) from Cannabis Indica using a Lecithin-
PG6C10-limonene DtableEM diluted 10/90 with Dsol.

| | | THC- | Total |
|---|---|---|---|
| Process parameter | THC | A | THC |
| Cannabinoid in flower before extraction (mg/ | 5.04 | 203.7 | 183.7 |
| g) | | | |
| Cannabinoid in flower after extraction (mg/ | 1.87 | 40.6 | 37.5 |
| g) | | | |
| OSEP Extraction Efficiency (extracted/ | 62.9% | 80.1% | 79.6% |
| initial) | | | |

As indicated in Table 2, the diluted extraction media (DtedEM), containing 90% Dsol, was capable of removing both THC and THC-A and producing a total THC-equivalent (converting THC-A to THC equivalent based on the ratio of molecular weights) removal of 79.6%. The mass of oily surfactant extracted phase (OSEP) obtained after decanting was 20.5 grams.

### Example 2. Refinement of Le-PG6C10-Limonene DtableEM OSEP, Using Hydrophilic Linker (HL) and Water Removal Steps, into a Refined Extract (RefEx)

According to Table 2, the total THC equivalent removed from 6 grams of ground flowers would be 0.184*6*0.796=0.879 grams. Considering that 20.5 grams of decanted OSEP were obtained, the concentration of equivalent THC in the oily phase is 0.879/(20.5)=0.043 or 4.3 wt %. The refinement process of this example has the purpose of increasing the concentration of the extracted THC using steps aimed at removing part of the hydrophilic linker and any solubilized water, as illustrated in FIG. 3A.

Following the procedure of FIG. 3A, the 20.5 grams of the OSEP obtained in Example 1 were then mixed with the hydrophilic linker (HL) antisolvent, n-heptane, at a mass ratio OSEP:n-heptane 1:1 in a 100 mL glass bottle. The system was then vortex-mixed for 10 minutes at 100 rpm, which produced an initial HL precipitation. The bottle was then left to settle (solids separation in FIG. 3A) for one hour, and the supernatant liquid was decanted into a separate 100 mL glass bottle. Additional HL precipitate along with any water or waxy residue was then removed by overnight (12 hours) cooling at −18 Celsius. The unfrozen portion of the oily phase was then decanted into a 100 mL glass bottle (second solid separation in FIG. 3A). This liquid was then placed in a hot plate to heat the sample to 100° C. for 180 minutes to evaporate the HL antisolvent (n-heptane) and any solubilized water that could remain until that point. The cannabinoid composition of the resulting refined extract (RefEx) is indicated in Table 3.

TABLE 3
Refining performance of OSEP obtained
with Le-PG6C10-limonene DtableEM

| Process parameter | Value |
|---|---|
| THC in RefEx, mg/g | 96.05 |
| THC-A in RefEx, mg/g | 0 |
| Total THC in RefEx, wt % | 9.6% |
| Mass of RefEx, g | 10.51 |
| RefEx total THC recovery efficiency (recovered/initial) | 91.5% |

The data in Table 3 shows that the refining procedure increased the total THC concentration in the extract by more than two folds while producing a recovery similar to the extraction efficiency (considering typical 10% error in combined analytical and experimental uncertainties), demonstrating minimal THC losses during refining.

### Example 3. Cannabinoid Extraction into an OSEP Using Le-PG6C10-Limonene:Ethyl Oleate (80:20) Dilutable Extracting Media (DtableEM)

The dilutable extracting media (DtableEM) was produced by mixing 40 parts (by mass) of limonene (technical grade, EACN=+6)+10 parts of ethyl oleate (EACN=+9.5) and 50 parts of a lecithin-linker mixture. The lecithin-linker mixture was prepared by mixing 10 parts (by mass) of soybean-extracted lecithin (Le) with 90 parts of PG6C10. The DtableEM was then mixed with the diluting solution (Dsol) of Example 1. FIG. 4, row (b) shows pictures of DtedEMs obtained with different levels of Dsol. These DtedEM were vortex-mixed and then left to equilibrate for two hours to detect the presence of multiphase systems. Table 4 summarizes the phase behavior obtained using different dilution ratios, including the viscosity and drop size.

Cannabis Indica (6 grams) were extracted with 12 grams of the Le-PG6C10-Limonene:ethyl oleate (80:20) DtableEM diluted with 108 grams of Dsol, following the procedure described in Example 1. Table 5 presents the initial and final THC and THC-A content in the ground flowers, along with the extraction efficiency.

TABLE 4
Composition, and number of phases obtained upon dilution of
a Le-PG6C10-Limonene:ethyl oleate (80:20) DtableEM. Columns
(a) through (d) represent the weight percentage of (a) Le;
(b) PG6C10; (c) Dsol; (d) limonene:ethyl oleate (80:20).

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 5 | 45 | 0 | 50 | 1 | | |
| 50/50 | 2.5 | 22.5 | 50 | 25 | 1 | 33 | |
| 40/60 | 2 | 18 | 60 | 20 | 1 | | |
| 30/70 | 1.5 | 13.5 | 70 | 15 | 1 | 22 | |
| 20/80 | 1.0 | 9.0 | 80 | 10 | 1 | | |
| 10/90 | 0.5 | 4.5 | 90 | 5 | 1 | 2.1 | 59 |

TABLE 5
Extraction performance of THC into an OSEP from
Cannabis Indica using a Lecithin-PG6C10-limonene:
ethyl oleate DtableEM diluted 10/90 with Dsol.

| | | THC- | Total |
|---|---|---|---|
| Process parameter | THC | A | THC |
| Cannabinoid in flower before extraction (mg/ | 5.04 | 203.7 | 183.7 |
| g) | | | |
| Cannabinoid in flower after extraction (mg/ | 1.73 | 36.0 | 33.3 |
| g) | | | |
| DtableEM Extraction Efficiency (extracted/ | 65.8% | 82.3% | 81.9% |
| initial) | | | |

The mass of (OSEP) obtained after decanting was 21.5 grams, for an equivalent total THC concentration in the OSEP of 4.4 wt %.

### Example 4. Refinement of Le-PG6C10-Limonene:Ethyl Oleate DtableEM OSEP, Using Hydrophilic Linker (HL) and Water Removal Steps, into a Refined Extract (RefEx)

Following the procedure illustrated in FIG. 3A, and described in Example 2, applied to the OSEP obtained in Example 3, the extraction performance shown in Table 6 was obtained.

TABLE 6
Refining performance of OSEP obtained with
Le-PG6C10-limonene: ethyl oleate DtableEM

| Process parameter | value |
|---|---|
| THC in RefEx, mg/g | 85.06 |
| THC-A in RefEx, mg/g | 0.83 |
| Total THC in RefEx, wt % | 8.6% |
| Mass of RefEx, g | 8.62 |
| RefEx total THC recovery efficiency (recovered/initial) | 67.3% |

The data in Table 6 shows that the refining procedure increased the total THC concentration in the extract from 4.4% to 8.6% while producing a recovery of 67.1%, which now becomes smaller than the extraction efficiency of 81.9%. For this example, the refinement process had a more noticeable effect on potential losses of total THC. Also, a fraction of THC-A is still seen in this example after refinement.

### Example 5. Cannabinoid Extraction into an OSEP Using Le-PG6C10-Limonene:Ethyl Caprate (80:20) Dilutable Extracting Media (DtableEM)

The dilutable extracting media (DtableEM) was produced by mixing 40 parts (by mass) of limonene (technical grade, EACN=+6)+10 parts of ethyl caprate (EACN=+4.5) and 50 parts of a lecithin-linker mixture. The lecithin-linker mixture was prepared by mixing 10 parts (by mass) of soybean-extracted lecithin (Le) with 90 parts of PG6C10. The DtableEM was then mixed with the diluting solution (Dsol) of Example 1. Row (c) of FIG. 4 shows pictures of DtedEMs obtained with different levels of Dsol. These DtedEM were vortex-mixed and then left to equilibrate for two hours to detect the presence of multiphase systems. Table 7 summarizes the phase behavior obtained using different dilution ratios, including the viscosity and drop size.

Cannabis Indica (6 grams) were extracted with 12 grams of the Le-PG6C10-Limonene:ethyl caprate (80:20) DtableEM diluted with 108 grams of Dsol following the procedure described in Example 1. Table 8 presents the initial and final THC and THC-A content in the ground flowers, along with the extraction efficiency.

TABLE 7
Composition, and number of phases obtained upon dilution of
a Le-PG6C10-Limonene:ethyl caprate (80:20) DtableEM. Columns
(a) through (d) represent the weight percentage of (a) Le;
(b) PG6C10; (c) Dsol; (d) limonene:ethyl caprate (80:20).

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 5 | 45 | 0 | 50 | 1 | | |
| 50/50 | 2.5 | 22.5 | 50 | 25 | 1 | 32 | |
| 40/60 | 2 | 18 | 60 | 20 | 1 | | |
| 30/70 | 1.5 | 13.5 | 70 | 15 | 1 | 22 | |
| 20/80 | 1.0 | 9.0 | 80 | 10 | 1 | | |
| 10/90 | 0.5 | 4.5 | 90 | 5 | 1 | 5.1 | 31 |

TABLE 8
Extraction performance of THC into an OSEP from
Cannabis Indica using a Lecithin-PG6C10-limonene:
ethyl caprate DtableEM diluted 10/90 with Dsol.

| | | THC- | Total |
|---|---|---|---|
| Process parameter | THC | A | THC |
| Cannabinoid in flower before extraction (mg/ | 5.04 | 203.7 | 183.7 |
| g) | | | |
| Cannabinoid in flower after extraction (mg/ | 2.06 | 30.5 | 28.8 |
| g) | | | |
| DtableEM Extraction Efficiency (extracted/ | 59.0% | 85.0% | 84.3% |
| initial) | | | |

The mass of (OSEP) obtained after decanting was 20.6 grams, for an equivalent total THC concentration in the OSEP of 4.5 wt %.

### Example 6. Refinement of Le-PG6C10-Limonene:Ethyl Caprate DtableEM OSEP, Using Hydrophilic Linker (HL) and Water Removal Steps, into a Refined Extract (RefEx)

Following the procedure illustrated in FIG. 3A, and described in Example 2, applied to the OSEP obtained in Example 5, the extraction performance shown in Table 9 was obtained.

TABLE 9
Refining performance of OSEP obtained with
Le-PG6C10-limonene: ethyl caprate DtableEM

| Process parameter | Value |
|---|---|
| THC in RefEx, mg/g | 93.4 |
| THC-A in RefEx, mg/g | 0.82 |
| Total THC in RefEx, wt % | 9.4% |
| Mass of RefEx, g | 6.94 |
| RefEx total THC recovery efficiency (recovered/initial) | 59.3% |

The data in Table 9 shows that the refining procedure increased the total THC concentration in the extract from 4.5% to 9.4% while producing a recovery of 59.3%, which now becomes substantially smaller than the total THC extraction efficiency of 84.3% shown in Table 8. The largest reason for the increased THC losses in this refinement example is the lower mass of RefEx recovered reported in Table 9. A comparison of the recoveries obtained in Examples 2, 4 and 6 illustrates the importance of selecting the extraction solvent used in the DtableEM and its impact on the refinement process.

### Example 7. Cannabinoid Extraction into an OSEP Using a D50 Le-PG6C10-Cyclohexane Dilutable Extracting Media (DtableEM)

The dilutable extracting media (DtableEM) was produced by mixing 50 parts (by mass) of cyclohexane (technical grade, EACN=+3) and 50 parts of a lecithin-linker mixture (to produce a D50 dilution line). The lecithin-linker mixture was prepared by mixing 10 parts (by mass) of soybean-extracted lecithin (Le) with 90 parts of PG6C10. The DtableEM was then mixed with the diluting solution (Dsol) of Example 1. FIG. 4, row (d) shows pictures of DtedEMs obtained with different levels of Dsol. These DtedEM were vortex-mixed and then left to equilibrate for two hours to detect the presence of multiphase systems. Table 10 summarizes the phase behavior obtained using different dilution ratios, including the viscosity and drop size.

Six grams of Cannabis Indica were extracted with 12 grams of the D50 Le-PG6C10-cyclohexane DtableEM diluted with 108 grams of Dsol, following the procedure described in Example 1. Table 11 presents the initial and final THC and THC-A content in the ground flowers, along with the extraction efficiency.

TABLE 10
Composition and number of phases obtained upon dilution of a
D50 Le-PG6C10-cyclohexane DtableEM. Columns (a) through (d)
represent the weight percentage of (a) Le; (b) PG6C10; (c)
Dsol; (d) cyclohexane. The term μE + lvLC represents
the coexistence of microemulsion with a low viscosity liquid crystal.

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 5 | 45 | 0 | 50 | 1 | | |
| 50/50 | 2.5 | 22.5 | 50 | 25 | μE + | 25 | |
| | | | | | lvLC | | |
| 40/60 | 2 | 18 | 60 | 20 | μE + | | |
| | | | | | lvLC | | |
| 30/70 | 1.5 | 13.5 | 70 | 15 | 1 | 12 | |
| 20/80 | 1.0 | 9.0 | 80 | 10 | 1 | | |
| 10/90 | 0.5 | 4.5 | 90 | 5 | 1 | 2.9 | 68 |

TABLE 11
Extraction performance of THC into an OSEP from
Cannabis Indica using a D50 Lecithin-PG6C10-
cyclohexane DtableEM diluted 10/90 with Dsol.

| | | THC- | Total |
|---|---|---|---|
| Process parameter | THC | A | THC |
| Cannabinoid in flower before extraction (mg/g) | 5.04 | 203.7 | 183.7 |
| Cannabinoid in flower after extraction (mg/g) | 3.53 | 53.6 | 50.7 |
| DtableEM Extraction Efficiency (extracted/ | 30% | 74% | 72.4% |
| initial) | | | |

The mass of (OSEP) obtained after decanting was 21.5 grams, for an equivalent total THC concentration in the OSEP of 3.7 wt %.

### Example 8. Refinement of D50 Le-PG6C10-Cyclohexane DtableEM OSEP, Using HL, Solvent Oil and Water Removal Steps, into a Refined Extract (RefEx)

The refinement process of this example has the purpose of increasing the concentration of the extracted THC using steps aimed at removing part of the hydrophilic linker, any solubilized water, and the solvent oil (cyclohexane), as illustrated in FIG. 3b.

Following the procedure of FIG. 3B, the 21.5 grams of the OSEP obtained in Example 7 were mixed with the hydrophilic linker (HL) antisolvent, n-heptane, at a mass ratio OSEP:n-heptane 1:1.2 in a 100 mL glass bottle. The system was then vortex-mixed for 10 minutes at 100 rpm, which produced an initial HL precipitation. The bottle was then left to settle (solids separation in FIG. 3B) for one hour, and the supernatant liquid was decanted into a separate 100 mL glass bottle. This liquid was then placed in a hot plate to heat the sample to 75° C. for 60 minutes to evaporate the solvent oil (cyclohexane). After cooling the same to room temperature, additional HL precipitate was removed by overnight (12 hours) cooling at −18 Celsius. The unfrozen portion of the oily phase was then decanted into a 100 mL glass bottle (second solid separation in FIG. 3B). This liquid was placed in a hot plate to heat the sample to 100° C. for 180 minutes to evaporate the HL antisolvent (n-heptane) and any residual solubilized water. The cannabinoid composition of the resulting refined extract (RefEx) is indicated in Table 12.

TABLE 12
Refining performance of OSEP with
D50 Le-PG6C10-cyclohexane DtableEM

| Process parameter | value |
|---|---|
| THC in RefEx, mg/g | 162.7 |
| THC-A in RefEx, mg/g | 0 |
| Total THC in RefEx, wt % | 16.27% |
| Mass of RefEx, g | 4.0 |
| RefEx total THC recovery efficiency (recovered/initial) | 59.0% |

The data in Table 12 shows that the refining procedure increased the total THC concentration in the extract by more than four folds while producing a recovery just below the extraction efficiency of 72% in Table 11 (considering typical 10% error in combined analytical and experimental uncertainties), demonstrating minimal THC losses during refining.

### Example 9. Cannabinoid Extraction into an OSEP Using a D30 Le-PG6C10-Cyclohexane Dilutable Extracting Media (DtableEM)

The dilutable extracting media (DtableEM) was produced by mixing 70 parts (by mass) of cyclohexane (technical grade, EACN=+3) and 30 parts of a lecithin-linker mixture (to produce a D30 dilution line). The lecithin-linker mixture was prepared by mixing 10 parts (by mass) of soybean-extracted lecithin (Le) with 90 parts of PG6C10. The DtableEM was then mixed with the diluting solution (Dsol) of Example 1. FIG. 4, row (e) shows pictures of DtedEMs obtained with different levels of Dsol. These DtedEM were vortex-mixed and then left to equilibrate for two hours to detect the presence of multiphase systems. Table 13 summarizes the phase behavior obtained using different dilution ratios, including the viscosity and drop size.

Six grams of Cannabis Indica were extracted with 12 grams of the D30 Le-PG6C10-cyclohexane DtableEM diluted with 108 grams of Dsol, following the procedure described in Example 1. Table 14 presents the initial and final THC and THC-A content in the ground flowers, along with the extraction efficiency.

TABLE 13
Composition and number of phases obtained upon dilution
of a D30 Le-PG6C10-cyclohexane DtableEM. Columns
(a) through (d) represent the weight percentage of
(a) Le; (b) PG6C10; (c) Dsol; (d) cyclohexane.

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 3 | 27 | 0 | 70 | 1 | | |
| 50/50 | 1.5 | 13.5 | 50 | 35 | 1 | 25 | |
| 40/60 | 1.2 | 10.8 | 60 | 28 | 1 | | |
| 30/70 | 0.9 | 8.1 | 70 | 21 | 1 | 15 | |
| 20/80 | 0.6 | 5.4 | 80 | 14 | 1 | | |
| 10/90 | 0.3 | 2.7 | 90 | 7 | 1 | 3.4 | 13 |

TABLE 14
Extraction performance of THC into an OSEP from
Cannabis Indica using a D30 Lecithin-PG6C10-
cyclohexane DtableEM diluted 10/90 with Dsol.

| | | | Total |
|---|---|---|---|
| Process parameter | THC | THC-A | THC |
| Cannabinoid in flower before extraction (mg/g) | 5.04 | 203.7 | 183.7 |
| Cannabinoid in flower after extraction (mg/g) | 3.29 | 52.6 | 49.5 |
| DtableEM Extraction Efficiency (extracted/ | 35% | 74% | 73.1% |
| initial) | | | |

The mass of (OSEP) obtained after decanting was 15.8 grams, for an equivalent total THC concentration in the OSEP of 5.1 wt %.

### Example 10. Refinement of D30 Le-PG6C10-Cyclohexane DtableEM OSEP, Using HL, Solvent Oil and Water Removal Steps, into a Refined Extract (RefEx)

The refinement process of this example has the purpose of increasing the concentration of the extracted THC using steps aimed at removing part of the hydrophilic linker, any solubilized water, and the solvent oil (cyclohexane), as illustrated in FIG. 3B.

Following the procedure of FIG. 3b, the 15.8 grams of the OSEP obtained in Example 9 were mixed with the hydrophilic linker (HL) antisolvent, n-heptane, at a mass ratio OSEP:n-heptane 1:1.2 in a 100 mL glass bottle. The system was then vortex-mixed for 10 minutes at 100 rpm, which produced an initial HL precipitation. The bottle was then left to settle (solids separation in FIG. 3B) for one hour, and the supernatant liquid was decanted into a separate 100 mL glass bottle. This liquid was then placed in a hot plate to heat the sample to 75° C. for 90 minutes to evaporate the solvent oil (cyclohexane). After cooling the same to room temperature, additional HL precipitate was removed by overnight (12 hours) cooling at −18 Celsius. The unfrozen portion of the oily phase was then decanted into a 100 mL glass bottle (second solid separation in FIG. 3B). This liquid was placed in a hot plate to heat the sample to 100° C. for 180 minutes to evaporate the HL antisolvent (n-heptane) and any residual solubilized water. The cannabinoid composition of the resulting refined extract (RefEx) is indicated in Table 15.

TABLE 15
Refining performance of OSEP with
D30 Le-PG6C10-cyclohexane DtableEM

| Process parameter | value |
|---|---|
| THC in RefEx, mg/g | 219.7 |
| THC-A in RefEx, mg/g | 0 |
| Total THC in RefEx, wt % | 22.0% |
| Mass of RefEx, g | 3.4 |
| RefEx total THC recovery efficiency (recovered/initial) | 67.8% |

The data in Table 15 shows that the refining procedure increased the total THC concentration in the extract by more than four folds while producing a recovery close to the extraction efficiency of 73% in Table 14 (considering typical 10% error in combined analytical and experimental uncertainties), demonstrating minimal THC losses during refining.

### Example 11. Cannabinoid Extraction with Cyclohexane Only

One of the well-known methods to extract polar oils, including cannabinoids, is the use of organic solvents. To compare the extraction efficiency obtained with DtableEM and with organic solvents, five grams of Cannabis Indica were extracted with 77 grams (100 mL) of cyclohexane (technical grade). The flowers were ground using mortar and pestle to a size of 4 mm or smaller. A Kacsoo (Zenore) electric overhead stirrer mixer equipped with a stainless steel mixing paddle (55 mm) was used to mix the ground flower suspension at 400 rpm for 60 minutes. After that time, the extract was centrifuged for 30 minutes at 3750 rpm, using a Beckman Allegra 6R centrifuge, and then it was left to gravity-settle for 12 hours. After the solids were settled, the system was press-filtered to remove the solids residue. This extraction produced a single liquid organic phase. Table 16 summarizes the extraction performance obtained with cyclohexane.

TABLE 16
Extraction performance of THC from
Cannabis Indica using cyclohexane

| | | | Total |
|---|---|---|---|
| Process parameter | THC | THC-A | THC |
| Cannabinoid in flower before extraction | 4.65 | 210.6 | 189.4 |
| (mg/g) | | | |
| Cannabinoid in flower after extraction | 1.51 | 33.3 | 30.7 |
| (mg/g) | | | |
| Cyclohexane Extraction Efficiency | 67.5% | 84.2% | 83.8% |
| (extracted/initial) | | | |

The mass of extracted organic phase obtained after decanting was 64.4 grams, for an equivalent total THC concentration in the cyclohexane extract of 1.23 wt %.

Using cyclohexane-only as extraction media, one obtains ˜80% removal similar to those obtained with DTableEM; however, the cyclohexane-only extraction process uses 77 grams of the solvent to extract 5 grams of flowers, which is more than 10 times the cyclohexane used in D30 Le-PG6C10-cyclohexane DtableEM (7 grams of cyclohexane) or in D50 Le-PG6C10-cyclohexane DtableEM (5 grams of cyclohexane) to extract 6 grams of flower. The reduction of more than 10-fold in solvent use is an advantageous feature of DtableEM towards the reduction of energy associated with the evaporation of the solvent in the refinement step, along with solvent recovery costs.

Another undesirable aspect of the solvent-only process is the lack of an excess aqueous phase where potentially undesirable water-soluble or water-dispersible components such as residual pesticides can be removed.

### Example 12. Cannabinoid Extraction into an OSEP Using a Solventless Le-PG6C10 Extracting Media

The solventless extracting media consisted of a lecithin-linker mixture prepared by mixing 10 parts (by mass) of soybean-extracted lecithin (Le) with 90 parts of PG6C10.

Five grams of Cannabis Indica were extracted with 3 grams of the solventless Le-PG6C10 extracting media (used to maintain the same surfactant: flower ratio used in Example 9), diluted with 97 grams of Dsol, following the procedure described in Example 1. Table 17 presents the initial and final THC and THC-A content in the ground flowers, along with the extraction efficiency.

TABLE 17
Extraction performance of THC into an OSEP from
Cannabis Indica using a solventless Lecithin-
PG6C10 extracting media diluted 10/90 with Dsol.

| | | | Total |
|---|---|---|---|
| Process parameter | THC | THC-A | THC |
| Cannabinoid in flower before extraction | 6.087 | 185.126 | 168.4 |
| (mg/g) | | | |
| Cannabinoid in flower after extraction | 13.6069 | 151.891 | 146.8 |
| (mg/g) | | | |
| DtableEM Extraction Efficiency | −123.5% | 18.0% | 12.8% |
| (extracted/initial) | | | |

As illustrated in Table 17, using surfactant only, without including the solvent oil in the DtableEM composition, produces substantially lower total THC (12.8%) extraction efficiency when compared to the ˜80% total THC extraction achieved with the full DtableEM. The negative extraction efficiency obtained with THC is likely associated with the combined uncertainties of the extraction method and the analytical method.

### Example 13. Eugenol Extraction into an OSEP Using Le-PG6C10-Limonene:Ethyl Oleate (80:20) Dilutable Extracting Media (DtableEM)

The dilutable extracting media (DtableEM) was produced by mixing 40 parts (by mass) of limonene (technical grade, EACN=+6)+10 parts of ethyl oleate (EACN=+9.5) and 50 parts of a lecithin-linker mixture. The lecithin-linker mixture was prepared by mixing 10 parts (by mass) of soybean-extracted lecithin (Le) with 90 parts of PG6C10. The DtableEM was then mixed with mineral water, without added salts or surfactants, as the diluting solution (Dsol). Row (g) of FIG. 4 shows pictures of DtedEMs obtained with different levels of Dsol. These DtedEM were vortex-mixed and then left to equilibrate for two hours to detect the presence of multiphase systems. Table 18 summarizes the phase behavior obtained using different dilution ratios, including the viscosity and drop size.

TABLE 18
Composition, and number of phases obtained upon dilution of a
Le-PG6C10-Limonene:ethyl oleate (80:20) DtableEM. Columns (a)
through (d) represent the weight percentage of (a) Le; (b) PG6C10;
(c) water (Dsol); (d) limonene:ethyl oleate (80:20).

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 5 | 45 | 0 | 50 | 1 | | |
| 50/50 | 2.5 | 22.5 | 50 | 25 | 1 | 34 | |
| 40/60 | 2 | 18 | 60 | 20 | 1 | | |
| 30/70 | 1.5 | 13.5 | 70 | 15 | 1 | 21 | |
| 20/80 | 1.0 | 9.0 | 80 | 10 | 1 | | |
| 14/86 | 0.7 | 6.3 | 86 | 7 | 1 | 4.9 | 108 |

6 grams of clove buds (Syzygium aromaticum) were extracted with 120 grams of DtedEM prepared with 14 parts of Le-PG6C10-Limonene:ethyl oleate (80:20) DtableEM and 86 parts of Dsol (mineral water), following the procedure of Example 1. The oil in the buds before and after extraction was assessed via the extraction of 0.5 g of the ground buds with 10 mL of dichloromethane for 12 hours at room temperature. The sample was further diluted 10× with methanol and injected into a Waters HPLC equipped with a C18 column. The method was calibrated using standards of technical grade clove oil and detecting the peak via UV absorbance. The peak area to eugenol concentration produced a calibration curve with R\hat{ }2 of 0.99. Using the ratio of eugenol peak areas before and after extraction, an extraction efficiency of 70.6% was determined using a Lecithin-PG6C10-limonene:ethyl oleate DtableEM diluted 14/86 with water (Dsol).

The interfacial tension between the OSEP produced during the extraction and the excess aqueous phase was measured using a M6500 Grace Instruments spinning drop tensiometer at room temperature. The measured interfacial tension was 0.017 mN/m, confirming the production of low interfacial tension systems capable of facilitating the liberation of the extracted oil from the porous network of the biomass.

### Example 14. Cannabinoid Extraction into an OSEP Using a Lecithin-Free D50 Polyglycerol-6-Caprylate (G6CY)-Cyclohexane Dilutable Extracting Media (DtableEM)

The dilutable extracting media (DtableEM) was produced by mixing 50 parts (by mass) of cyclohexane (technical grade, EACN=+3) and 50 parts of G6CY (to produce a D50 dilution line). The DtableEM was then mixed with the diluting solution (Dsol) of Example 1. FIG. 4, row (f) shows pictures of DtedEMs obtained with different levels of Dsol. These DtedEM were vortex-mixed and then left to equilibrate for two hours to detect the presence of multiphase systems. Table 19 summarizes the phase behavior obtained using different dilution ratios, including the viscosity and drop size.

Six grams of Cannabis Indica were extracted with 12 grams of the D50 G6CY-cyclohexane DtableEM diluted with 108 grams of Dsol, following the procedure described in Example 1. Table 20 presents the initial and final THC and THC-A content in the ground flowers, along with the extraction efficiency.

TABLE 19
Composition and number of phases obtained upon dilution
of a D50 G6CY-cyclohexane DtableEM. Columns (a)
through (d) represent the weight percentage of
(a) Le; (b) G6CY; (c) Dsol; (d) cyclohexane.

| DTableEM/ | | | % | | | Viscosity | Diameter |
|---|---|---|---|---|---|---|---|
| Dsol | %(a) | %(b) | (c) | %(d) | Phases | cP | nm |
| 100/0 | 0 | 50 | 0 | 50 | 1 | | |
| 50/50 | 0 | 25 | 50 | 25 | 1 | 32.78 | |
| 40/60 | 0 | 20 | 60 | 20 | 1 | | |
| 30/70 | 0 | 15 | 70 | 15 | 1 | 21.6 | |
| 20/80 | 0 | 10 | 80 | 10 | 1 | | |
| 10/90 | 0 | 5 | 90 | 5 | 1 | 3.88 | 14.3 |

TABLE 20
Extraction performance of THC into an OSEP
from Cannabis Indica using a D50 G6CY-cyclohexane
DtableEM diluted 10/90 with Dsol.

| | | | Total |
|---|---|---|---|
| Process parameter | THC | THC-A | THC |
| Cannabinoid in flower before extraction (mg/g) | 4.65 | 210.64 | 189.38 |
| Cannabinoid in flower after extraction (mg/g) | 3.59 | 57.10 | 53.67 |
| DtableEM Extraction Efficiency (extracted/ | 23% | 73% | 71.7% |
| initial) | | | |

The mass of (OSEP) obtained after decanting was 18.5 grams, for an equivalent total THC concentration in the OSEP of 4.4 wt %.

### Example 15. Cannabinoid Extraction into an OSEP Using Le-PG6C10/PG10C10 (20/80)-Limonene Dilutable Extracting Media (DtableEM) and Reduced Solid to Liquid Ratio 1:10

The dilutable extracting media (DtableEM) was produced by mixing 40 parts (by mass) of limonene (technical grade) and 60 parts of a lecithin-linker mixture. The lecithin-linker mixture was prepared by mixing 10 parts (by mass) of soybean-extracted lecithin (Le) with 18 parts of PG6C10 and 72 parts of PG10C10. The DtableEM was then mixed with different levels of mineral water (Dsol) to produce DtedEMs. These DtedEM were vortex-mixed and then left to equilibrate for two hours to detect the presence of multiphase systems. Table 21 summarizes the phase behavior obtained using different dilution ratios.

Cannabis Indica (6 grams) were extracted with 6 grams of the Le-PG6C10/PG10C10-Limonene DtableEM diluted with 54 grams of mineral water (Dsol) following the procedure described in Example 1. Table 22 presents the initial and final THC and THC-A content in the ground flowers, along with the extraction efficiency.

TABLE 21
Composition, and number of phases obtained upon dilution of a
Le-PG6C10/PG10C10-Limonene DtableEM. Columns (a) through (d)
represent the weight percentage of (a) Le; (b) PG6C10 +
PG10C10 (at 20/80 ratio); (c) Dsol; (d) limonene.

| DTableEM/Dsol | %(a) | %(b) | % (c) | %(d) | Phases |
|---|---|---|---|---|---|
| 100/0 | 6 | 54 | 0 | 40 | 1 |
| 50/50 | 3 | 27 | 50 | 20 | 1 |
| 40/60 | 2.4 | 21.6 | 60 | 16 | 1 |
| 30/70 | 1.8 | 16.2 | 70 | 12 | 1 |
| 20/80 | 1.2 | 10.8 | 80 | 8 | 1 |
| 10/90 | 0.6 | 5.4 | 90 | 4 | 1 |

TABLE 22
Extraction performance of THC into an OSEP from
Cannabis Indica using a Lecithin- PG6C10/PG10C10-
limonene diluted 10/90 with Dsol.

| | | | Total |
|---|---|---|---|
| Process parameter | THC | THC-A | THC |
| Cannabinoid in flower before extraction (mg/g) | 25.6 | 209.4 | 209.3 |
| Cannabinoid in flower after extraction (mg/g) | 16.0 | 67.5 | 75.2 |
| DtableEM Extraction Efficiency (extracted/ | 38.0% | 68% | 64% |
| initial) | | | |

The mass of (OSEP) obtained after decanting was 5.9 grams, for an equivalent total THC concentration in the OSEP of 13.6 wt %.

### Example 16. Cannabinoid Extraction into an OSEP Using Le-PG6C10/PG10C10 (20/80 Ratio)-Limonene Dilutable Extracting Media (DtableEM) at 5° C., 25° C. And 40° C. And Solid to Liquid Ratio 1:15

The DtableEM was produced by mixing 40 parts (by mass) of limonene (technical grade) and 60 parts of a lecithin-linker mixture. The lecithin-linker mixture was prepared by mixing 10 parts (by mass) of soybean-extracted lecithin (Le) with 18 parts of PG6C10 and 72 parts of PG10C10.

Cannabis Indica (5 grams) were extracted at 5° C. and 40° C. with 7.5 grams of the Le-PG6C10/PG10C10-Limonene DtableEM diluted with 67.5 grams of mineral water (Dsol) following the procedure described in Example 1. Cannabis Indica (6 grams) at 25° C. were extracted with 9 grams of the Le-PG6C10/PG10C10-Limonene DtableEM diluted with 81 grams of mineral water (Dsol) following the procedure described in Example 1. Table 23, 24 and 25 present the initial and final THC and THC-A content in the ground flowers, along with the extraction efficiency at 5° C., 25° C. and 40° C., respectively.

TABLE 23
Extraction performance of THC into an OSEP from
Cannabis Indica using a Lecithin- PG6C10/PG10C10-
limonene diluted 10/90 with Dsol at 5° C.

| | | | Total |
|---|---|---|---|
| Process parameter | THC | THC-A | THC |
| Cannabinoid in flower before extraction (mg/g) | 15.4 | 262.1 | 245.3 |
| Cannabinoid in flower after extraction (mg/g) | 6.5 | 63.7 | 62.3 |
| DtableEM Extraction Efficiency (extracted/ | 58.0% | 76% | 75% |
| initial) | | | |

The mass of (OSEP) obtained after decanting was 11.5 grams, for an equivalent total THC concentration in the OSEP of 8 wt %.

TABLE 24
Extraction performance of THC into an OSEP from
Cannabis Indica using a Lecithin- PG6C10/PG10C10-
limonene diluted 10/90 with Dsol at 25° C.

| | | | Total |
|---|---|---|---|
| Process parameter | THC | THC-A | THC |
| Cannabinoid in flower before extraction | 13.4 | 272.1 | 252 |
| (mg/g) | | | |
| Cannabinoid in flower after extraction | 7 | 57.7 | 57.6 |
| (mg/g) | | | |
| DtableEM Extraction Efficiency (extracted/ | 47.7% | 78.8% | 77.1% |
| initial) | | | |

The mass of (OSEP) obtained after decanting was 12.93 grams, for an equivalent total THC concentration in the OSEP of 9 wt %.

TABLE 25
Extraction performance of THC into an OSEP from
Cannabis Indica using a Lecithin- PG6C10/PG10C10
(20/80)-limonene diluted 10/90 with Dsol at 40° C.

| | | | Total |
|---|---|---|---|
| Process parameter | THC | THC-A | THC |
| Cannabinoid in flower before extraction | 15.4 | 262.1 | 245.3 |
| (mg/g) | | | |
| Cannabinoid in flower after extraction | 8.3 | 75.4 | 74.4 |
| (mg/g) | | | |
| DtableEM Extraction Efficiency (extracted/ | 46.3% | 71.2% | 69.7% |
| initial) | | | |

The mass of (OSEP) obtained after decanting was 11.2 grams, for an equivalent total THC concentration in the OSEP of 7.6 wt %.

The DtableEM extraction efficiency at room temperature (25° C.) is slightly larger than the extraction obtained at 5° C. and 40° C. Given the added costs of heating or cooling the extraction vessel, the data shows that one advantageous feature of the process is the relatively high efficiency at room temperature, thus avoiding the need for added heating or cooling during the extraction stage. Compared to the extraction efficiency with the solid:liquid ratio of 1:10 used in Example 15, the extraction efficiency at room temperature and solid:liquid ratio of 1:15 in Table 24 is substantially improved.

### Example 17. Cannabinoid Extraction into an OSEP Using Le-PG6C10/PG10C10 (20/80)-Limonene Dilutable Extracting Media (DtableEM), Using Hybrid Indica Flower at a Larger Scale at a Solid:Liquid Ratio of 1:15

The DtableEM was produced by mixing 40 parts (by mass) of limonene (technical grade) and 60 parts of a lecithin-linker mixture. The lecithin-linker mixture was prepared by mixing 10 parts (by mass) of soybean-extracted lecithin (Le) with 18 parts of PG6C10 and 72 parts of PG10C10. The DtedEM produced with 10/90 DtableEM/Dsol ratio was used to conduct the extraction procedure. The biomass used in this example was Cannabis wedding cake. 50 grams of the flowers were ground using mortar and pestle to a size of 4 mm. The 50 grams of ground flowers were mixed with 750 grams of the 10/90 DtedEM in a 2 L beaker. A Fisherbrand Power Overhead Stirrer equipped with a 78 mm paint mixing paddle was used to mix the ground flower suspension at 130 rpm for 60 minutes. After that time, the extract was centrifuged for 30 minutes at 8000 rpm (10016×g), using a Ohaus Frontier FC5916/R Angle centrifuge, and then it was left to gravity-settle for 2.5 hours, allowing for any oily surfactant phase drops trapped in the biomass to be released. After the solids settled, the system was press-filtered to remove the solids, and the two-phase liquid portion was then centrifuged at 8000 rpm (10016×g) for 15 min. The top oily surfactant extract phase (OSEP) was then decanted from the top, and the excess aqueous residue was gravity-drained for disposal. The wet biomass was left to dry in the air for further analysis. Table 26 presents the initial and final THC and THC-A content in the ground flowers, along with the extraction efficiency.

TABLE 26
Extraction performance of THC into an OSEP from
Cannabis wedding cake using a Lecithin- PG6C10/PG10C10-
limonene diluted 10/90 with Dsol at 25° C.

| | | | Total |
|---|---|---|---|
| Process parameter | THC | THC-A | THC |
| Cannabinoid in flower before extraction | 8.3 | 181.7 | 167.6 |
| (mg/g) | | | |
| Cannabinoid in flower after extraction | 4.1 | 36.9 | 36.5 |
| (mg/g) | | | |
| DtableEM Extraction Efficiency (extracted/ | 50.5% | 79.7% | 78.2% |
| initial) | | | |

The mass of (OSEP) obtained after decanting was 74.9 grams, for an equivalent total THC concentration in the OSEP of 8.75 wt %.

Comparing the data in the Tables 24 and 26 shows that scaling up the process by 10 times has not significant effect on extraction efficiency and total THC concentration in the OSEP.

### Example 18. Cannabinoid Extraction into an OSEP Using Le-PG6C10/PG10C10 (40/60 Ratio)-Limonene Dilutable Extracting Media (DtableEM), Using Hybrid Indica Flower at Solid:Liquid of 1:15

The DtableEM was produced by mixing 40 parts (by mass) of limonene (technical grade) and 60 parts of a lecithin-linker mixture. The lecithin-linker mixture was prepared by mixing 10 parts (by mass) of soybean-extracted lecithin (Le) with 36 parts of PG6C10 and 54 parts of PG10C10. The DtableEM was then mixed with different levels of mineral water (Dsol) to produce DtedEMs. These DtedEM were vortex-mixed and then left to equilibrate for two hours to detect the presence of multiphase systems. Table 27 summarizes the phase behavior obtained using different dilution ratios.

TABLE 27
Composition, and number of phases obtained upon dilution of a
Le-PG6C10/PG10C10-Limonene DtableEM. Columns (a) through (d)
represent the weight percentage of (a) Le; (b) PG6C10 +
PG10C10 (at 40:60 ratio); (c) Dsol; (d) limonene.

| DTableEM/Dsol | %(a) | %(b) | % (c) | %(d) | Phases |
|---|---|---|---|---|---|
| 100/0 | 6 | 54 | 0 | 40 | 1 |
| 50/50 | 3 | 27 | 50 | 20 | 1 |
| 40/60 | 2.4 | 21.6 | 60 | 16 | 1 |
| 30/70 | 1.8 | 16.2 | 70 | 12 | 1 |
| 20/80 | 1.2 | 10.8 | 80 | 8 | 1 |
| 10/90 | 0.6 | 5.4 | 90 | 4 | 1 |

Cannabis wedding cake (25 grams) were extracted with 37.5 grams of the Le-PG6C10/PG10C10-Limonene DtableEM diluted with 337.5 grams of mineral water (Dsol) following the procedure described in Example 17. Table 28 presents the initial and final THC and THC-A content in the ground flowers, along with the extraction efficiency.

TABLE 28
Extraction performance of THC into an OSEP from
Cannabis wedding cake using a Lecithin- PG6C10/PG10C10(40/60)-
limonene diluted 10/90 with Dsol.

| | | | Total |
|---|---|---|---|
| Process parameter | THC | THC-A | THC |
| Cannabinoid in flower before extraction (mg/g) | 8.3 | 181.7 | 167.6 |
| Cannabinoid in flower after extraction (mg/g) | 4.6 | 40.2 | 39.8 |
| DtableEM Extraction Efficiency (extracted/ | 45% | 77.9% | 76.2% |
| initial) | | | |

The mass of (OSEP) obtained after decanting was 27.2 grams, for an equivalent total THC concentration in the OSEP of 11.74 wt %.

Comparing the data in the Tables 26 and 28 shows that increasing the ratio of PG6C10/PG10C10 from 20/80 to 40/60 does not change the DtableEM extraction efficiency.

### Example 19. Cannabinoid (CBD) Extraction into an OSEP Using Le-PG6C10/PG10C10 (40/60)-Limonene Dilutable Extracting Media (DtableEM) at 1:15 Solid:Liquid Ratio

The DtableEM was produced by mixing 40 parts (by mass) of limonene (technical grade) and 60 parts of a lecithin-linker mixture. The lecithin-linker mixture was prepared by mixing 10 parts (by mass) of soybean-extracted lecithin (Le) with 36 parts of PG6C10 and 54 parts of PG10C10. The DtableEM was then mixed with different levels of mineral water (Dsol) to produce DtedEMs.

Cannabis (CBD) Indica (25 grams) were extracted with 37.5 grams of the Le-PG6C10/PG10C10-Limonene DtableEM diluted with 337.5 grams of mineral water (Dsol). Table 29 presents the initial and final CBD and CBD-A content in the ground flowers, along with the extraction efficiency.

TABLE 29
Extraction performance of CBD into an OSEP from
Cannabis Indica using a Lecithin- PG6C10/PG10C10
(40/60 ratio) - limonene diluted 10/90 with Dsol.

| | | | Total |
|---|---|---|---|
| Process parameter | CBD | CBD-A | CBD |
| Cannabinoid in flower before extraction (mg/g) | 23.6 | 89 | 101.7 |
| Cannabinoid in flower after extraction (mg/g) | 8.4 | 26.9 | 32 |
| DtableEM Extraction Efficiency (extracted/ | 64.4% | 69.8% | 69% |
| initial) | | | |

The mass of (OSEP) obtained after decanting was 36.86 grams, for an equivalent total CBD concentration in the OSEP of 4.76 wt %.

Comparing the THC vs. the CBD extraction in Tables 28 and 29, respectively, one observes comparable extraction levels, albeit slightly smaller for CBD.

### REFERENCES CITED

[1]S. M. B. Hashemi, A. M. Khaneghah, M. S. Sant'Ana, Essential oils in food processing: Chemistry, safety and applications, first, John Wiley & Sons, Ltd, Hoboken, NJ, 2017. https://doi.org/10.1002/9781119149392.
[2]A. El Asbahani, K. Miladi, W. Badri, M. Sala, E. H. A. Addi, H. Casabianca, A. El Mousadik, D. Hartmann, A. Jilale, F. N. R. Renaud, A. Elaissari, Essential oils: From extraction to encapsulation, Int. J. Pharm. 483 (2015) 220-243. https://doi.org/10.1016/j. ijpharm.2014.12.069.
[3]M.-H. Cheng, B. S. Dien, V. Singh, Economics of plant oil recovery: A review, Biocatal. Agric. Biotechnol. 18 (2019). https://doi.org/10.1016/j.bcab.2019.101056.
[4]T. Moreno, F. Montanes, S. J. Tallon, T. Fenton, J. W. King, Extraction of cannabinoids from hemp (Cannabis sativa L.) using high pressure solvents: An overview of different processing options, J. Supercrit. Fluids. 161 (2020) 104850. https://doi.org/10.1016/j.supflu.2020.104850.
[5]L. D. Do, D. A. Sabatini, Pilot scale study of vegetable oil extraction by surfactant-assisted aqueous extraction process, Sep. Sci. Technol. 46 (2011) 978-985. https://doi.org/10.1080/01496395.2010.541401.
[6]N. T. Dunford, Advancements in Oil and Oilseed Processing, in: N. T. Dunford (Ed.), Food Ind. Bioprod. Bioprocess., first, John Wiley & Sons, Inc., 2012: pp. 115-143. https://doi.org/10.1002/9781119946083.ch4.
[7]M. Sagir, M. Mushtaq, M. S. Tahir, M. B. Tahir, A. R. Shaik, Surfactants for enhanced oil recovery applications, 2020. https://doi.org/10.1007/978-3-030-18785-9.
[8]J. Chan, Extracting Lipid and Carotenoids from Microalgae with LecithinLinker Microemulsions, University of Toronto, 2012. http://hdl.handle.net/1807/42883.
[9]A. Knowles, Recent developments of safer formulations of agrochemicals, Environmentalist. 28 (2008) 35-44. https://doi.org/10.1007/s10669-007-9045-4.
[10]E. J. Acosta, J. H. Harwell, D. A. Sabatini, Self-assembly in linker-modified microemulsions, J. Colloid Interface Sci. 274 (2004) 652-664. https://doi.org/10.1016/j.jcis.2004.03.037.
[11]S. Zarate-Muñoz, F. TexeiraDe Vasconcelos, K. Myint-Myat, J. Minchom, E. J. Acosta, A Simplified Methodology to Measure the Characteristic Curvature (Cc) of Alkyl Ethoxylate Nonionic Surfactants, J. Surfactants Deterg. 19 (2016) 249-263. https://doi.org/10.1007/s11743-016-1787-x.
[12]A. Ghayour, E. Acosta, Characterizing the Oil-like and Surfactant-like Behavior of Polar Oils, Langmuir. 35 (2019) 15038-15050. https://doi.org/10.1021/acs.langmuir.9b02732.
[13]E. J. Acosta, S. Sundar, How to Formulate Biobased Surfactants Through the HLD-NAC Model, in: D. Hayes, D. Solaiman, R. Ashby (Eds.), Biobased Surfactants, 2nd ed., AOCS Press, London, U. K., 2019: pp. 471-510. https://doi.org/10.1016/B978-0-12-812705-6.00015-0.
[14]M. Nouraei, E. J. Acosta, Predicting solubilisation features of ternary phase diagrams of fully dilutable lecithin linker microemulsions, J. Colloid Interface Sci. 495 (2017) 178-190. https://doi.org/10.1016/j.jcis.2017.01.114.
[15]A. Ghayour, E. J. Acosta, Erratum: Characterizing the Oil-like and Surfactant-like Behavior of Polar Oils, Langmuir. 36 (2020) 3276-32771. https://doi.org/10.1021/acs.langmuir.0c00510.
[16]E. J. Acosta, M. A. Le, J. H. Harwell, D. A. Sabatini, Coalescence and solubilization kinetics in linker-modified microemulsions and related systems, Langmuir. 19 (2003) 566-574. https://doi.org/10.1021/la0261693.
[17]E. J. Acosta, Bioavailability of nanoparticles in nutrient and nutraceutical delivery, Curr. Opin. Colloid Interface Sci. 14 (2009) 3-15. https://doi.org/10.1016/j.cocis.2008.01.002.
[18]S. Quraishi, M. Bussmann, E. Acosta, Capillary Curves for Ex-situ Washing of Oil-Coated Particles, J. Surfactants Deterg. 18 (2015) 811-823. https://doi.org/10.1007/s11743-015-1704-8.
[19]E. J. Acosta, S. Quraishi, Surfactant Technologies for Remediation of Oil Spills, in: Ponisseril Somasundaran, P. Patra, R. S. Farinato, K. Papadopoulos (Eds.), Oil Spill Remediat. Colloid Chem. Princ. Solut., first, Wiley, Hoboken, NJ, 2014: pp. 317-358. https://doi.org/10.1002/9781118825662.ch15.
[20]W. McCabe, J. Smith, P. Harriott, Unit Operations of Chemical Engineering, Seventh, McGraw-Hill, New York, NY, 2005.
[21]M. J. Rosen, J. T. Kunjappu, Surfactants and Interfacial Phenomena, Fourth, John Wiley & Sons, Inc., Hoboken, NJ, USA, 2012. https://doi.org/10.1002/9781118228920.

All publications cited herein are incorporated by reference.

Although the description above contains many specificities, these should not be construed as limiting the scope of the disclosure, but as merely providing illustrations of some of the presently embodiments of this disclosure.

1. A method of extraction of one or more polar oils from a biomass substrate into an oily surfactant extract phase (OSEP), the method comprising:
b_i) mixing an aqueous diluting solution (Dsol), a dilutable extraction media (DtableEM) and the biomass substrate containing one or more polar oils to obtain a mixture having a biomass residue and a liquid phase, the liquid phase comprising an emulsified OSEP and an excess aqueous phase, the DtableEM comprising: (a) 0 to 10% of a surfactant, having at least one hydrocarbon group with 12 to 18 carbon atoms; (b) a hydrophilic linker, having one hydrocarbon group with 6 to 10 carbon atoms; and (c) a solvent oil, excluding linear alkanes;
b_ii) separating the biomass residue in the mixture from the liquid phase comprising the emulsified OSEP phase and the excess aqueous phase; and
b_iii) separating the excess aqueous phase from the emulsified OSEP to obtain the OSEP containing the extracted one or more polar oils.

2. The method of extraction of claim 1, wherein upon addition of the Dsol the DtableEM produces a diluted extraction media (DtedEM), and wherein the biomass substrate containing one or more polar oils: DtedEM ratio is from 1:6 to 1:60, or of 1:10 to 1:20.

3-4. (canceled)

5. The method of extraction of claim 1, wherein the DtableEM:Dsol ratio in the mixture ranges between about 50:50 and 5:95.

6. (canceled)

7. The method of extraction of claim 1, wherein when the DtableEM comprises more than 0% of the surfactant, and wherein the surfactant is lecithin or a lecithin derivative.

8. The method of extraction of claim 1, wherein the DtableEM includes 0% of the surfactant.

9. (canceled)

10. The method of extraction of claim 1, wherein the hydrophilic linker comprises one or more of C6-C10 esters of polyhydric alcohols, polyvinyl alcohol, polyglycerols and their co-polymers with a degree of polymerization (n) higher than 2 (n>2), sucrose, maltose, oligosaccharides, polyglucosides (n>2), polyglucosamines, sorbitol, sorbitan, poly alpha hydroxy acids and their salts, C6-C10 phosphatidylcholines, phosphatidyl glycerols, or mixtures thereof.

11. (canceled)

12. The method of extraction of claim 1, wherein the solvent oil includes cyclohexane, fatty acid ethyl esters and terpenes.

13. The method of extraction of claim 1, the solvent oil comprises of alkyl esters of fatty acids, monoglycerides, diglycerides, triglycerides, non-linear alkanes, terpenes, or mixtures thereof.

14. The method of extraction of claim 1, wherein the solvent oil has a positive equivalent alkane carbon number (EACN).

15. The method of extraction of claim 1, wherein the solvent oil concentration in the DtableEM is about 10 wt % to about 80 wt %.

16. The method of extraction of claim 1, wherein the extracted one or more polar oils has/have a positive characteristic curvature (Cc), a molecular weight between 50 and 1,000 Daltons, a polar area greater than 0.0 Λ², an aqueous solubility less than about 1 wt %, and a positive log P.

17. The method of extraction of claim 1, wherein the extracted one or more polar oils include/s one or more hydrogen bonding donor compounds selected from a group consisting of C5+ alcohols, amines, peptides, organic acids, anthranilic acids, aryl propionic acids, enolic acids, heteroaryl acetic acids, indole and indene acetic acids, salicylic acid derivatives, nucleic acids, alkylphenols, para-aminophenol derivatives, terpene phenolics, cannabinoids, alkaloids, peptides, and halogenated compounds.

18. The method of extraction of claim 1, wherein the Dsol is mineral, distilled, tap water or an aqueous solution that contains less than 1 wt % of a mixture of additives, wherein the mixture of additives in the Dsol includes one or more of electrolytes, polymers, and surfactants.

19. (canceled)

20. A method of extraction of a polar oil from a biomass substrate into an oily surfactant extract phase (OSEP), the method comprising
i) placing a biomass substrate in a single-phase system free of polar oil, but comprising a diluted extraction media (DtedEM) located above the phase boundary region of the ternary phase diagram for said system, to achieve the establishment of a biomass residue phase and a liquid phase comprising the OSEP and an excess aqueous phase;
ii) phase separating the biomass residue phase formed in i) from the liquid phase; and
iii) separating the excess aqueous phase from the liquid phase to obtain the OSEP containing the extracted polar oil,
wherein the DtedEM comprises the DtableEM as defined in claim 1 and an aqueous solution (Dsol).

21. The method of claim 20, wherein the DtableEM:Dsol ratio in the mixture ranges between 50:50 and 5:95, DtableEM to Dsol ratio in the mixture ranges between about 50 wt % to about 95 wt %.

22. A method for refining the oily surfactant extract phase (OSEP) obtained in step b_iii of claim 1 into a refined extract (RefEx) with higher concentration of the extracted one or more polar oils, the method comprising one or more of the following steps:
c_i) mixing the OSEP containing the extracted one or more polar oils obtained in step b_iii of claim 1 with a hydrophilic linker antisolvent to precipitate hydrophilic linker in the OSEP, and separating the precipitated hydrophilic linker, the hydrophilic linker antisolvent being a linear alkane with five or more carbon atoms to obtain a RefEx with higher concentration of the extracted polar oil relative to the OSEP obtain in b_iii of claim 1.

23. The method of claim 22, wherein the method further comprises:
c_iii: cooling the resulting OSEP of c_i to induce solidification of the hydrophilic linker and aqueous solution into solids, and separating the solids, thereby obtaining an OSEP substantially free of hydrophilic linker and aqueous solution; and
c_iv: removing the hydrophilic linker antisolvent by heating the resulting OSEP of c_iii at a temperature at or above the boiling point of the hydrophilic linker antisolvent, to obtain the RefEx with higher concentration of the extracted polar oil relative to the OSEP obtained in b_iii of claim 1.

24. The method of claim 22, wherein the method further comprises:
c_ii) heating the resulting OSEP of c_i to evaporate the solvent oil from the OSEP at a temperature above the boiling point of the solvent oil to obtain an OSEP substantially free of the solvent oil.

25. The method of claim 22, wherein the mixing of step c_i is conducted at a temperature below the largest value between the melting point of the solvent oil, the aqueous solution and/or the antisolvent.

26. The method of claim 22, wherein the method further comprises;
c_ii) heating the resulting OSEP of c_i to evaporate the solvent oil from the OSEP at a temperature above the boiling point of the solvent oil to obtain an OSEP substantially free of the solvent oil; and
c_iv: removing the hydrophilic linker antisolvent by heating the resulting OSEP of c_ii at a temperature at or above the boiling point of the hydrophilic linker antisolvent, to obtain the RefEx with higher concentration of the extracted polar oil relative to the OSEP obtained in b_iii of claim 1.

27. (canceled)

28. The method of claim 22, wherein the method further comprises:
c_ii) heating the resulting OSEP of c_i to evaporate the solvent oil from the OSEP at a temperature above the boiling point of the solvent oil to obtain an OSEP substantially free of the solvent oil; and
c_iv: removing the hydrophilic linker antisolvent by heating the resulting OSEP of c_ii at a temperature at or above the boiling point of the hydrophilic linker antisolvent, to obtain the RefEx with higher concentration of the extracted polar oil relative to the OSEP obtained in b_iii of claim 1.

29. The method of extraction of claim 1, wherein the DtableEM is lecithin free.
